(19) United States
(12) Patent Application Publication
(10) Pub. No.: US 2026/0304470 A1
(43) Pub. Date: Oct. 1, 2026

(54) CYCLIC PREFIX EXTENSION SELECTION FOR A SHARED CHANNEL OCCUPANCY TIME

(71) Applicant: QUALCOMM Incorporated, San Diego, CA (US)

(72) Inventors: Giovanni CHISCI, San Diego, CA (US); Chih-Hao LIU, San Diego, CA (US); Jing SUN, San Diego, CA (US); Xiaoxia ZHANG, San Diego, CA (US); Stelios STEFANATOS, San Diego, CA (US)

(21) Appl. No.: 19/477,408

(22) PCT Filed: Apr. 30, 2024
(86) PCT No.: PCT/US2024/026996

§ 371 Date: Oct. 21, 2025

(30) Foreign Application Priority Data
May 11, 2023 (GR) 20230100382

(51) Int. Cl. H04W 74/04; H04W 92/18

(52) U.S. Cl. CPC H04W 74/04; H04W 92/18

(57) ABSTRACT

Various aspects of the present disclosure generally relate to wireless communication. In some aspects, a first user equipment (UE) may receive, from a second UE, channel occupancy time (COT) sharing information (COT-SI) indicating at least an offset, a channel access type, and a cyclic prefix extension (CPE) associated with a shared COT. The first UE may select the channel access type and the CPE, as indicated by the COT-SI, based at least in part on a sidelink transmission to be transmitted at the offset. The first UE may perform the sidelink transmission within the shared COT based at least in part on an outcome of a channel access procedure and the CPE. Numerous other aspects are described.

### CROSS-REFERENCE TO RELATED APPLICATION

This Patent Application claims priority to Greece Patent Application No. 20230100382, filed on May 11, 2023, entitled “CYCLIC PREFIX EXTENSION SELECTION FOR A SHARED CHANNEL OCCUPANCY TIME,” and assigned to the assignee hereof. The disclosure of the prior Application is considered part of and is incorporated by reference into this Patent Application.

### INTRODUCTION

Aspects of the present disclosure generally relate to wireless communication and to techniques and apparatuses for a cyclic prefix extension (CPE) selection.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed at a first user equipment (UE). The method may include receive, from a second UE, channel occupancy time (COT) sharing information (COT-SI) associated with a shared COT.

The method may include select a channel access type and a cyclic prefix extension (CPE) in an autonomous manner based at least in part on the COT-SI, wherein the channel access type is one or more of a default channel access type or an upgraded channel access type, and the upgraded channel access type is based at least in part on a detection of another sidelink transmission in a slot prior to a sidelink transmission. The method may include perform the sidelink transmission within the shared COT based at least in part on an outcome of a channel access procedure and the CPE.

Some aspects described herein relate to a method of wireless communication performed at a first UE. The method may include receiving, from a second UE, COT-SI indicating at least an offset, a channel access type, and a CPE associated with a shared COT. The method may include selecting the channel access type and the CPE, as indicated by the COT-SI, based at least in part on a sidelink transmission to be transmitted at the offset. The method may include performing the sidelink transmission within the shared COT based at least in part on an outcome of a channel access procedure and the CPE.

Some aspects described herein relate to a method of wireless communication performed at a first UE. The method may include receiving, from a second UE, COT-SI indicating at least an offset, a first channel access type, and a first CPE associated with a shared COT. The method may include selecting, in an autonomous manner, a second channel access type and a second CPE, different or same from the first channel access type and the second CPE indicated by the COT-SI, based at least in part on a sidelink transmission to be transmitted after the offset. The method may include performing the sidelink transmission within the shared COT based at least in part on an outcome of a channel access procedure and the second CPE.

Some aspects described herein relate to a method of wireless communication performed at a first UE. The method may include receiving, from a second UE, COT-SI associated with a shared COT. The method may include selecting a channel access type and a CPE in an autonomous manner based at least in part on the channel access type and the CPE being excluded from the COT-SI. The method may include performing a sidelink transmission within the shared COT based at least in part on an outcome of a channel access procedure and the CPE.

Some aspects described herein relate to a method of wireless communication performed at a second UE. The method may include splitting a COT into a first sub-COT and a second sub-COT. The method may include transmitting, to a first set of UEs, a first COT-SI that indicates at least a first offset and a first duration associated with the first sub-COT. The method may include transmitting, to a second set of UEs, a second COT-SI that indicates at least a second offset and a second duration associated with the second sub-COT.

Some aspects described herein relate to an apparatus for wireless communication at a first UE. The apparatus may include one or more memories and one or more processors coupled to the one or more memories. The one or more processors may be configured to receive, from a second UE, COT-SI indicating at least an offset, a channel access type, and a CPE associated with a shared COT. The one or more processors may be configured to select the channel access type and the CPE, as indicated by the COT-SI, based at least in part on a sidelink transmission to be transmitted at the offset. The one or more processors may be configured to perform the sidelink transmission within the shared COT based at least in part on an outcome of a channel access procedure and the CPE.

Some aspects described herein relate to an apparatus for wireless communication at a first UE. The apparatus may include one or more memories and one or more processors coupled to the one or more memories. The one or more processors may be configured to receive, from a second UE, COT-SI indicating at least an offset, a first channel access type, and a first CPE associated with a shared COT. The one or more processors may be configured to select, in an autonomous manner, a second channel access type and a second CPE, different or same from the first channel access type and the second CPE indicated by the COT-SI, based at least in part on a sidelink transmission to be transmitted after the offset. The one or more processors may be configured to perform the sidelink transmission within the shared COT based at least in part on an outcome of a channel access procedure and the second CPE.

Some aspects described herein relate to an apparatus for wireless communication at a first UE. The apparatus may include one or more memories and one or more processors coupled to the one or more memories. The one or more processors may be configured to receive, from a second UE, COT-SI associated with a shared COT. The one or more processors may be configured to select a channel access type and a CPE in an autonomous manner based at least in part on the channel access type and the CPE being excluded from the COT-SI. The one or more processors may be configured to perform a sidelink transmission within the shared COT based at least in part on an outcome of a channel access procedure and the CPE.

Some aspects described herein relate to an apparatus for wireless communication at a second UE. The apparatus may include one or more memories and one or more processors coupled to the one or more memories. The one or more processors may be configured to split a COT into a first sub-COT and a second sub-COT. The one or more processors may be configured to transmit, to a first set of UEs, a first COT-SI that indicates at least a first offset and a first duration associated with the first sub-COT. The one or more processors may be configured to transmit, to a second set of UEs, a second COT-SI that indicates at least a second offset and a second duration associated with the second sub-COT.

Some aspects described herein relate to an apparatus for wireless communication at a first UE. The apparatus may include one or more memories storing processor-executable code. The apparatus may include one or more processors coupled with the one or more memories and individually or collectively operable to receive, from a second UE, COT-SI indicating at least an offset, a channel access type, and a CPE associated with a shared COT. The apparatus may include one or more processors coupled with the one or more memories and individually or collectively operable to select the channel access type and the CPE, as indicated by the COT-SI, based at least in part on a sidelink transmission to be transmitted at the offset. The apparatus may include one or more processors coupled with the one or more memories and individually or collectively operable to perform the sidelink transmission within the shared COT based at least in part on an outcome of a channel access procedure and the CPE.

Some aspects described herein relate to an apparatus for wireless communication at a first UE. The apparatus may include one or more memories storing processor-executable code. The apparatus may include one or more processors coupled with the one or more memories and individually or collectively operable to receive, from a second UE, COT-SI indicating at least an offset, a first channel access type, and a first CPE associated with a shared COT. The apparatus may include one or more processors coupled with the one or more memories and individually or collectively operable to select, in an autonomous manner, a second channel access type and a second CPE, different or same from the first channel access type and the second CPE indicated by the COT-SI, based at least in part on a sidelink transmission to be transmitted after the offset. The apparatus may include one or more processors coupled with the one or more memories and individually or collectively operable to perform the sidelink transmission within the shared COT based at least in part on an outcome of a channel access procedure and the second CPE.

Some aspects described herein relate to an apparatus for wireless communication at a first UE. The apparatus may include one or more memories storing processor-executable code. The apparatus may include one or more processors coupled with the one or more memories and individually or collectively operable to receive, from a second UE, COT-SI associated with a shared COT. The apparatus may include one or more processors coupled with the one or more memories and individually or collectively operable to select a channel access type and a CPE in an autonomous manner based at least in part on the channel access type and the CPE being excluded from the COT-SI. The apparatus may include one or more processors coupled with the one or more memories and individually or collectively operable to perform a sidelink transmission within the shared COT based at least in part on an outcome of a channel access procedure and the CPE.

Some aspects described herein relate to an apparatus for wireless communication at a second UE. The apparatus may include one or more memories storing processor-executable code. The apparatus may include one or more processors coupled with the one or more memories and individually or collectively operable to split a COT into a first sub-COT and a second sub-COT. The apparatus may include one or more processors coupled with the one or more memories and individually or collectively operable to transmit, to a first set of UEs, a first COT-SI that indicates at least a first offset and a first duration associated with the first sub-COT. The apparatus may include one or more processors coupled with the one or more memories and individually or collectively operable to transmit, to a second set of UEs, a second COT-SI that indicates at least a second offset and a second duration associated with the second sub-COT.

Some aspects described herein relate to an apparatus for wireless communication at a first UE. The apparatus may include one or more memories. The apparatus may include one or more processors coupled with the one or more memories. The one or more processors are configured to cause the first UE to receive, from a second UE, COT-SI associated with a shared COT. The one or more processors are configured to cause the first UE to select a channel access type and a CPE in an autonomous manner based at least in part on the COT-SI, wherein the channel access type is one or more of a default channel access type or an upgraded channel access type, and the upgraded channel access type is based at least in part on a detection of another sidelink transmission in a slot prior to a sidelink transmission. The one or more processors are configured to cause the first UE to perform the sidelink transmission within the shared COT based at least in part on an outcome of a channel access procedure and the CPE.

Some aspects described herein relate to a non-transitory computer-readable medium that stores a set of instructions for wireless communication by a first UE. The set of instructions, when executed by one or more processors of the UE, may cause the UE to receive, from a second UE, COT-SI indicating at least an offset, a channel access type, and a CPE associated with a shared COT. The set of instructions, when executed by one or more processors of the UE, may cause the UE to select the channel access type and the CPE, as indicated by the COT-SI, based at least in part on a sidelink transmission to be transmitted at the offset. The set of instructions, when executed by one or more processors of the UE, may cause the UE to perform the sidelink transmission within the shared COT based at least in part on an outcome of a channel access procedure and the CPE.

Some aspects described herein relate to a non-transitory computer-readable medium that stores a set of instructions for wireless communication by an UE. The set of instructions, when executed by one or more processors of the UE, may cause the UE to receive, from a second UE, COT-SI indicating at least an offset, a first channel access type, and a first CPE associated with a shared COT. The set of instructions, when executed by one or more processors of the UE, may cause the UE to select, in an autonomous manner, a second channel access type and a second CPE, different or same from the first channel access type and the second CPE indicated by the COT-SI, based at least in part on a sidelink transmission to be transmitted after the offset. The set of instructions, when executed by one or more processors of the UE, may cause the UE to perform the sidelink transmission within the shared COT based at least in part on an outcome of a channel access procedure and the second CPE.

Some aspects described herein relate to a non-transitory computer-readable medium that stores a set of instructions for wireless communication by a first UE. The set of instructions, when executed by one or more processors of the first UE, may cause the first UE to receive, from a second UE, COT-SI associated with a shared COT. The set of instructions, when executed by one or more processors of the UE, may cause the first UE to select a channel access type and a CPE in an autonomous manner based at least in part on the channel access type and the CPE being excluded from the COT-SI. The set of instructions, when executed by one or more processors of the first UE, may cause the first UE to perform a sidelink transmission within the shared COT based at least in part on an outcome of a channel access procedure and the CPE.

Some aspects described herein relate to a non-transitory computer-readable medium that stores a set of instructions for wireless communication by a second UE. The set of instructions, when executed by one or more processors of the UE, may cause the UE to split a COT into a first sub-COT and a second sub-COT. The set of instructions, when executed by one or more processors of the UE, may cause the UE to transmit, to a first set of UEs, a first COT-SI that indicates at least a first offset and a first duration associated with the first sub-COT. The set of instructions, when executed by one or more processors of the UE, may cause the UE to transmit, to a second set of UEs, a second COT-SI that indicates at least a second offset and a second duration associated with the second sub-COT.

Some aspects described herein relate to a non-transitory computer-readable medium that stores a set of instructions for wireless communication by a first UE. The set of instructions, when executed by one or more processors of the first UE, may cause the first UE to receive, from a second UE, COT-SI associated with a shared COT. The set of instructions, when executed by one or more processors of the UE, may cause the first UE to select a channel access type and a CPE in an autonomous manner based at least in part on the COT-SI, wherein the channel access type is one or more of a default channel access type or an upgraded channel access type, and the upgraded channel access type is based at least in part on a detection of another sidelink transmission in a slot prior to a sidelink transmission. The set of instructions, when executed by one or more processors of the first UE, may cause the first UE to perform the sidelink transmission within the shared COT based at least in part on an outcome of a channel access procedure and the CPE.

Some aspects described herein relate to a first apparatus for wireless communication. The first apparatus may include means for receiving, from a second UE, COT-SI indicating at least an offset, a channel access type, and a CPE associated with a shared COT. The first apparatus may include means for selecting the channel access type and the CPE, as indicated by the COT-SI, based at least in part on a sidelink transmission to be transmitted at the offset. The first apparatus may include means for performing the sidelink transmission within the shared COT based at least in part on an outcome of a channel access procedure and the CPE.

Some aspects described herein relate to a first apparatus for wireless communication. The first apparatus may include means for receiving, from a second UE, COT-SI indicating at least an offset, a first channel access type, and a first CPE associated with a shared COT. The first apparatus may include means for selecting, in an autonomous manner, a second channel access type and a second CPE, different or same from the first channel access type and the second CPE indicated by the COT-SI, based at least in part on a sidelink transmission to be transmitted after the offset. The first apparatus may include means for performing the sidelink transmission within the shared COT based at least in part on an outcome of a channel access procedure and the second CPE.

Some aspects described herein relate to a first apparatus for wireless communication. The first apparatus may include means for receiving, from a second UE, COT-SI associated with a shared COT. The first apparatus may include means for selecting a channel access type and a CPE in an autonomous manner based at least in part on the channel access type and the CPE being excluded from the COT-SI. The first apparatus may include means for performing a sidelink transmission within the shared COT based at least in part on an outcome of a channel access procedure and the CPE.

Some aspects described herein relate to a second apparatus for wireless communication. The second apparatus may include means for splitting a COT into a first sub-COT and a second sub-COT. The second apparatus may include means for transmitting, to a first set of UEs, a first COT-SI that indicates at least a first offset and a first duration associated with the first sub-COT. The second apparatus may include means for transmitting, to a second set of UEs, a second COT-SI that indicates at least a second offset and a second duration associated with the second sub-COT.

Some aspects described herein relate to a first apparatus for wireless communication. The first apparatus may include means for receiving, from a second UE, COT-SI associated with a shared COT. The first apparatus may include means for selecting a channel access type and a CPE in an autonomous manner based at least in part on the COT-SI, wherein the channel access type is one or more of a default channel access type or an upgraded channel access type, and the upgraded channel access type is based at least in part on a detection of another sidelink transmission in a slot prior to a sidelink transmission. The first apparatus may include means for performing the sidelink transmission within the shared COT based at least in part on an outcome of a channel access procedure and the CPE.

Aspects generally include a method, apparatus, system, computer program product, non-transitory computer-readable medium, user equipment, base station, network entity, network node, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIGS. 4A-4B are diagrams illustrating examples associated with a cyclic prefix extension (CPE) selection for a shared channel occupancy time (COT), in accordance with the present disclosure.

FIGS. 5-15 are diagrams illustrating examples associated with a CPE selection for a shared COT, in accordance with the present disclosure.

FIGS. 16A-16B are diagrams illustrating examples associated with a CPE selection for a shared COT, in accordance with the present disclosure.

FIGS. 17-18 are diagrams illustrating examples associated with a CPE selection for a shared COT, in accordance with the present disclosure.

FIGS. 19-22 are diagrams illustrating example processes associated with a CPE selection for a shared COT, in accordance with the present disclosure.

FIG. 23 is a diagram of an example apparatus for wireless communication, in accordance with the present disclosure.

FIG. 24 is a diagram illustrating an example of a hardware implementation for an apparatus employing a processing system, in accordance with the present disclosure.

FIG. 25 is a diagram illustrating an example implementation of code and circuitry for an apparatus, in accordance with the present disclosure.

FIG. 26 is a diagram of an example apparatus for wireless communication, in accordance with the present disclosure.

FIG. 27 is a diagram illustrating an example of a hardware implementation for an apparatus employing a processing system, in accordance with the present disclosure.

FIG. 28 is a diagram illustrating an example implementation of code and circuitry for an apparatus, in accordance with the present disclosure.

FIG. 29 is a diagram illustrating an example process associated with a CPE selection for a shared COT, in accordance with the present disclosure.

### DETAILED DESCRIPTION

A user equipment (UE) may transmit a cyclic prefix extension (CPE), in accordance with a CPE starting position, before performing a sidelink transmission within a channel occupancy time (COT). The CPE may be a transmission that allows for a sufficient gap for a channel access. The COT may be a time during which a channel is occupied by the UE. The UE may transmit the CPE during a symbol 13, which may be associated with a gap symbol in a sidelink. By transmitting the CPE, the UE may be able to obtain the sufficient gap for performing the channel access (e.g., Type 2A, 2B, or 2C), which may allow the UE to subsequently transmit the sidelink transmission within the COT.

In New Radio unlicensed (NR-U), a network node may schedule the UE, and the COT may be fully under a control of the network node. The network node may indicate a channel access type (e.g., Type 2A, 2B, or 2C) to the UE. The network node may indicate the CPE to the UE. The UE may use the channel access type and the CPE indicated by the network node to perform a transmission within the COT.

In sidelink unlicensed (SL-U), a COT initiating UE may share the COT with a COT responding UE. However, unlike in NR-U, the COT initiating UE that shares the COT may not be able to schedule the COT responding UE. The COT responding UE, which may not be controlled by the COT initiating UE sharing the COT, may not be configured to appropriately select the channel access type and the CPE. The COT responding UE may not be configured to receive an indication of the channel access type and the CPE from the COT initiating UE. The COT responding UE may not be configured to autonomously determine the channel access type and the CPE (e.g., without input from the COT initiating UE). Accordingly, in some examples, the COT responding UE, when selecting the channel access type and the CPE without input from the COT initiating UE, may select a channel access type and/or a CPE that is associated with a relatively large gap. Since no transmissions are able to be performed during the relatively large gap, an overall performance of the COT initiating UE and/or the COT responding UE may be degraded.

In some aspects described herein, the COT initiating UE may provide COT sharing information (COT-SI) in a sidelink transmission, such as in a physical sidelink control channel (PSCCH) transmission or in a physical sidelink shared channel (PSSCH) transmission. The COT-SI may indicate information about a specific shared COT region. The COT responding UE may receive the COT-SI. The COT-SI may indicate an offset and a duration associated with the shared COT region. The offset and the duration may provide, to the COT responding UE, time domain information associated with the shared COT region. The COT-SI may or may not indicate the channel access type and the CPE associated with the shared COT region. In some examples, when the COT-SI indicates the channel access type and the CPE, the COT responding UE may select the channel access type and the CPE indicated in the COT-SI. In some examples, the COT-SI may indicate a channel access type and a CPE, but the COT responding UE may select a different channel access type and/or a different CPE than indicated in the COT-SI. In some examples, when the COT-SI does not indicate any channel access type or CPE, the COT responding UE may autonomously select the channel access type and the CPE. The UE may autonomously select the channel access type and the CPE by selecting the channel type and the CPE without an explicit indication of the channel access type and the CPE from the COT initiating UE. In some aspects, irrespectively of whether the COT responding UE selects the channel access type or the CPE indicated by the COT-SI, or autonomously selects the channel access type and the CPE, the COT responding UE may use the selected channel access type and CPE to perform a sidelink transmission. In some aspects, the UE may select the channel access type and the CPE in an autonomous manner based at least in part on the COT-SI, where the channel access type may be a default channel access type or an upgraded channel access type. The upgraded channel access type may be based at least in part on a detection of another sidelink transmission in a slot prior to the sidelink transmission.

In some aspects, depending on the COT initiating UE, configuring the COT-SI to indicate the channel access type and/or the CPE may improve an overall performance of the COT responding UE. When the COT initiating UE forms the COT and different regions of the COT are allocated for different UEs, explicitly indicating the channel access type and the CPE may allow the COT responding UE to follow the COT initiating UE's coordination. By explicitly indicating the channel access type and the CPE, the COT initiating UE may ensure that a risk of collisions is minimized, thereby improving an overall performance for the COT responding UE. When the COT initiating UE opens up the COT for sharing without coordination, the COT initiating UE may not explicitly indicate the channel access type and the CPE. Rather, the COT responding UE may be better suited to autonomously select the channel access type and the CPE, and the COT responding UE may be suited to independently resolve a potential collision (e.g., without input from the COT initiating UE). Depending on the objective of the COT initiating UE, the COT responding UE may be configured to support the different approaches.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

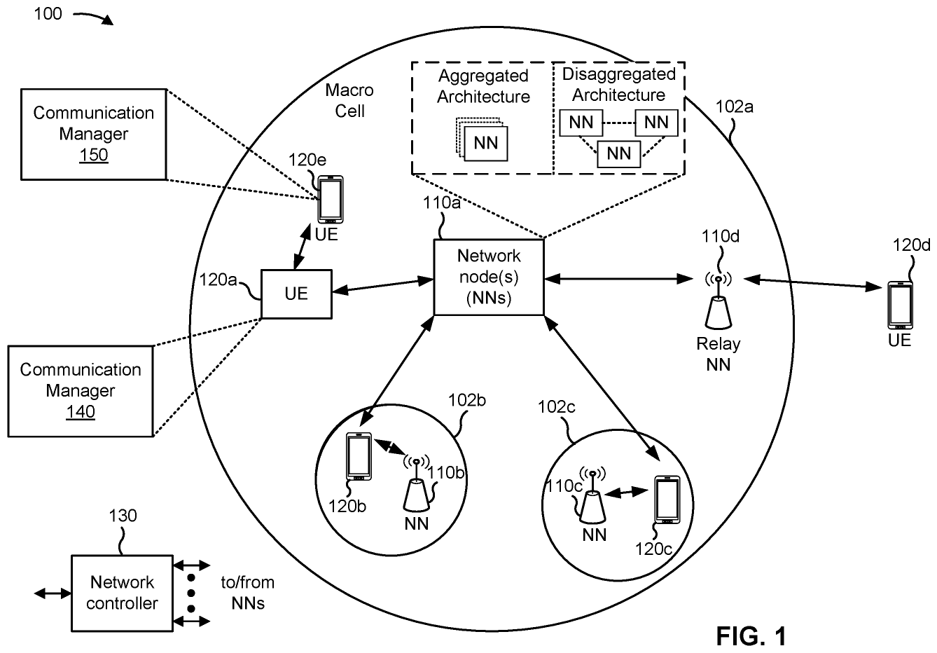

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

The electromagnetic spectrum is often subdivided, by frequency/wavelength, into various classes, bands, channels, etc. In 5G NR, two initial operating bands have been identified as frequency range designations FR1 (410 MHz-7.125 GHz) and FR2 (24.25 GHz- 52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first UE (e.g., UE 120a) may include a communication manager 140. As described in more detail elsewhere herein, the communication manager 140 may receive, from a second UE, COT-SI indicating at least an offset, a channel access type, and a CPE associated with a shared COT; select the channel access type and the CPE, as indicated by the COT-SI, based at least in part on a sidelink transmission to be transmitted at the offset; and perform the sidelink transmission within the shared COT based at least in part on an outcome of a channel access procedure and the CPE. Additionally, or alternatively, the communication manager 140 may perform one or more other operations described herein.

In some aspects, a first UE (e.g., UE 120a) may include a communication manager 140. As described in more detail elsewhere herein, the communication manager 140 may receive, from a second UE, COT-SI indicating at least an offset, a first channel access type, and a first CPE associated with a shared COT; select, in an autonomous manner, a second channel access type and a second CPE, different or same from the first channel access type and the second CPE indicated by the COT-SI, based at least in part on a sidelink transmission to be transmitted after the offset; and perform the sidelink transmission within the shared COT based at least in part on an outcome of a channel access procedure and the second CPE. Additionally, or alternatively, the communication manager 140 may perform one or more other operations described herein.

In some aspects, a first UE (e.g., UE 120a) may include a communication manager 140. As described in more detail elsewhere herein, the communication manager 140 may receive, from a second UE, COT-SI associated with a shared COT; select a channel access type and a CPE in an autonomous manner based at least in part on the channel access type and the CPE being excluded from the COT-SI; and perform a sidelink transmission within the shared COT based at least in part on an outcome of a channel access procedure and the CPE. Additionally, or alternatively, the communication manager 140 may perform one or more other operations described herein.

In some aspects, a first UE (e.g., UE 120a) may include a communication manager 140. As described in more detail elsewhere herein, the communication manager 140 may receive, from a second UE, COT-SI associated with a shared COT; select a channel access type and a CPE in an autonomous manner based at least in part on the COT-SI, wherein the channel access type is one or more of a default channel access type or an upgraded channel access type, and the upgraded channel access type is based at least in part on a detection of another sidelink transmission in a slot prior to a sidelink transmission; and perform the sidelink transmission within the shared COT based at least in part on an outcome of a channel access procedure and the CPE. Additionally, or alternatively, the communication manager 140 may perform one or more other operations described herein.

In some aspects, a second UE (e.g., UE 120e) may include a communication manager 150. As described in more detail elsewhere herein, the communication manager 150 may split a COT into a first sub-COT and a second sub-COT; transmit, to a first set of UEs, a first COT-SI that indicates at least a first offset and a first duration associated with the first sub-COT; and transmit, to a second set of UEs, a second COT-SI that indicates at least a second offset and a second duration associated with the second sub-COT. Additionally, or alternatively, the communication manager 150 may perform one or more other operations described herein.

As indicated above, FIG. 1 is provided as an example. Other examples may differ from what is described with regard to FIG. 1.

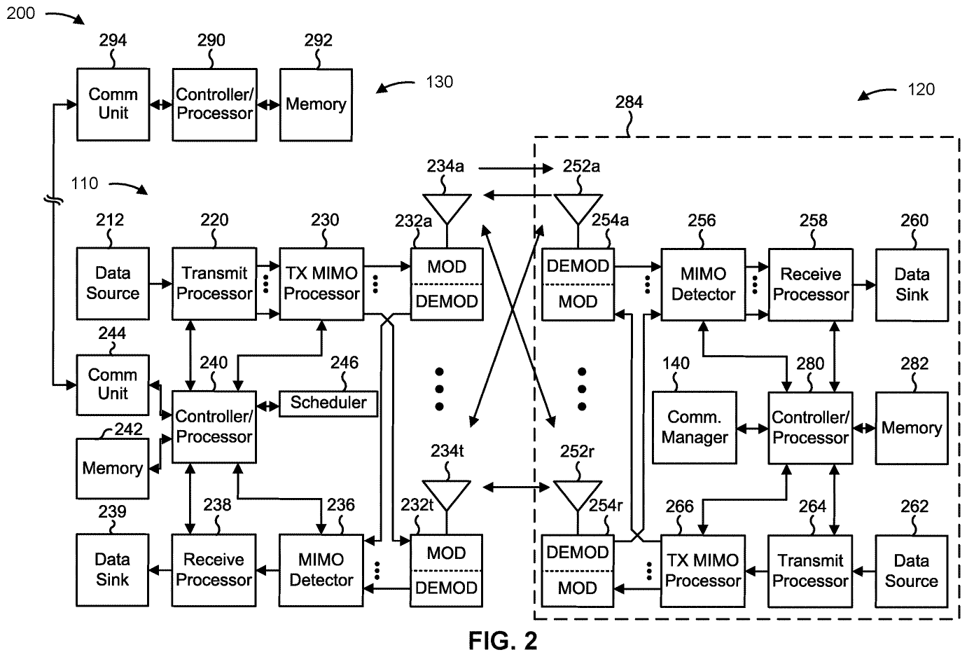

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein.

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein.

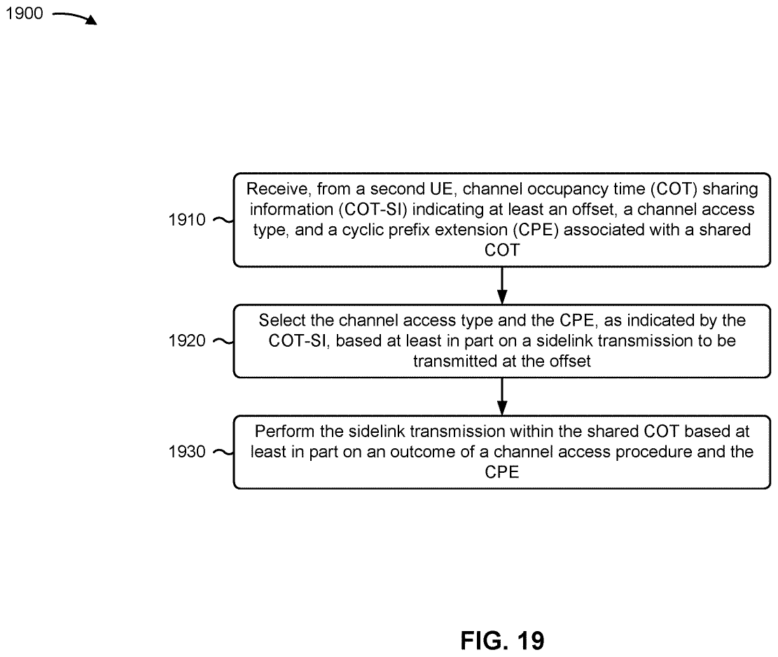

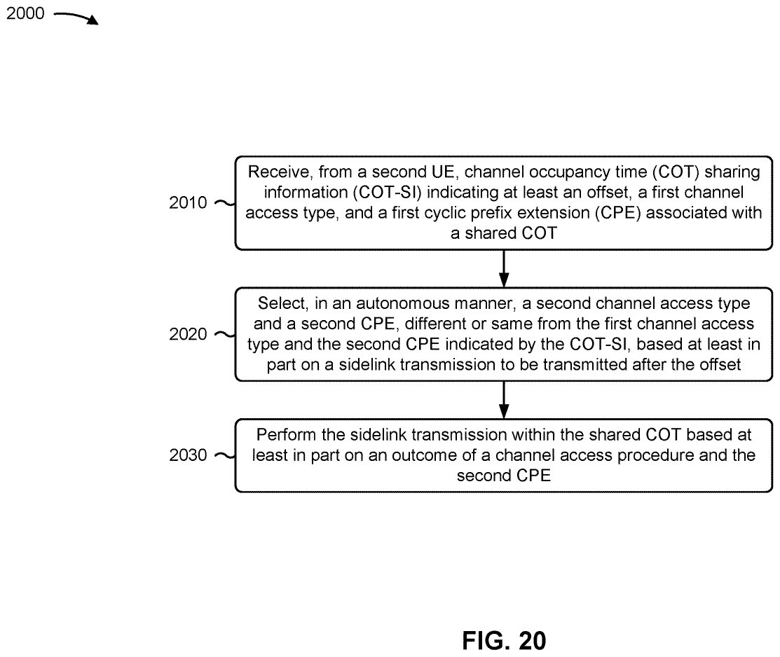

The controller/processor 240 of the network node 110, the controller/processor 280 of the UE 120, and/or any other component(s) of FIG. 2 may perform one or more techniques associated with a CPE selection for a shared COT, as described in more detail elsewhere herein. For example, the controller/processor 240 of the network node 110, the controller/processor 280 of the UE 120, and/or any other component(s) of FIG. 2 may perform or direct operations of, for example, process 1900 of FIG. 19, process 2000 of FIG. 20, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1900 of FIG. 19, process 2000 of FIG. 20, and/or other processes as described herein. In some examples, executing instructions may include running the instructions, converting the instructions, compiling the instructions, and/or interpreting the instructions, among other examples.

In some aspects, a first UE (e.g., UE 120a) includes means for receiving, from a second UE, COT-SI indicating at least an offset, a channel access type, and a CPE associated with a shared COT; means for selecting the channel access type and the CPE, as indicated by the COT-SI, based at least in part on a sidelink transmission to be transmitted at the offset; and/or means for performing the sidelink transmission within the shared COT based at least in part on an outcome of a channel access procedure and the CPE.

In some aspects, a first UE (e.g., UE 120a) includes means for receiving, from a second UE, COT-SI indicating at least an offset, a first channel access type, and a first CPE associated with a shared COT; means for selecting, in an autonomous manner, a second channel access type and a second CPE, different or same from the first channel access type and the second CPE indicated by the COT-SI, based at least in part on a sidelink transmission to be transmitted after the offset; and/or means for performing the sidelink transmission within the shared COT based at least in part on an outcome of a channel access procedure and the second CPE.

In some aspects, a first UE (e.g., UE 120a) includes means for receiving, from a second UE, COT-SI associated with a shared COT; means for selecting a channel access type and a CPE in an autonomous manner based at least in part on the channel access type and the CPE being excluded from the COT-SI; and/or means for performing a sidelink transmission within the shared COT based at least in part on an outcome of a channel access procedure and the CPE.

In some aspects, a first UE (e.g., UE 120a) includes means for receive, from a second UE, COT-SI associated with a shared COT; means for selecting a channel access type and a CPE in an autonomous manner based at least in part on the COT-SI, wherein the channel access type is one or more of a default channel access type or an upgraded channel access type, and the upgraded channel access type is based at least in part on a detection of another sidelink transmission in a slot prior to a sidelink transmission; and means for performing the sidelink transmission within the shared COT based at least in part on an outcome of a channel access procedure and the CPE.

In some aspects, a second UE (e.g., UE 120e) includes means for splitting a COT into a first sub-COT and a second sub-COT; means for transmitting, to a first set of UEs, a first COT-SI that indicates at least a first offset and a first duration associated with the first sub-COT; and/or means for transmitting, to a second set of UEs, a second COT-SI that indicates at least a second offset and a second duration associated with the second sub-COT.

The means for the first UE to perform operations described herein may include, for example, one or more of communication manager 140, antenna 252, modem 254, MIMO detector 256, receive processor 258, transmit processor 264, TX MIMO processor 266, controller/processor 280, or memory 282. The means for the second UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a second UE (e.g., UE 120e) includes means for transmitting, to a first UE, COT-SI indicating information associated with a shared COT, a channel access type and a CPE being based at least in part on the COT-SI. The means for the second UE to perform operations described herein may include, for example, one or more of communication manager 150, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

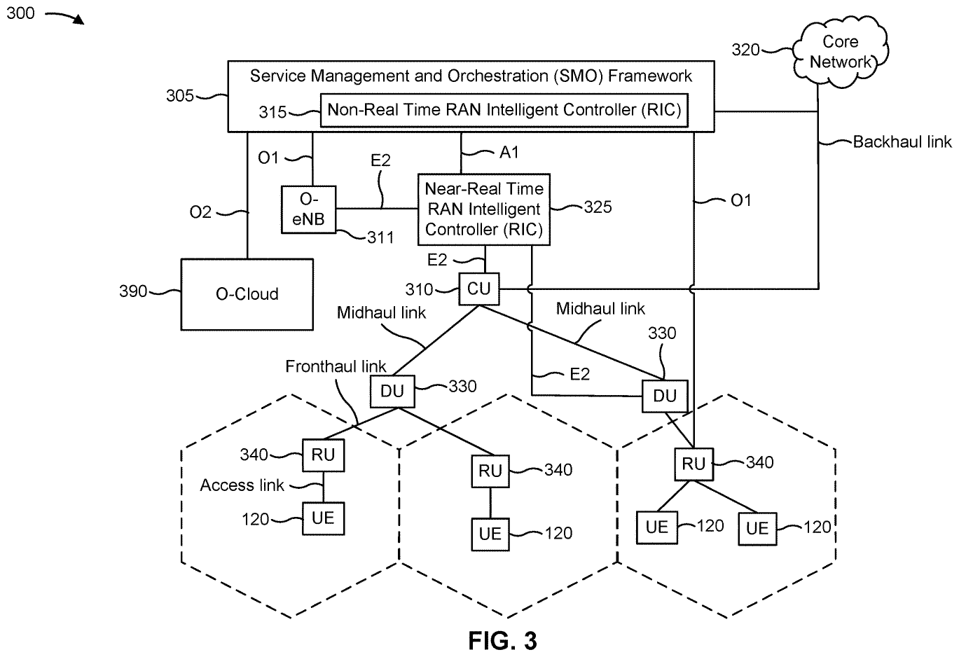

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

One or multiple CPEs may be preconfigured for a PSSCH. A selection framework may have a first criterion to select a default CPE (for concurrent transmissions) and a second criterion to select one among multiple CPEs (for time division multiplexing (TDM) transmissions). The one or multiple CPEs may be configured for the PSSCH when initiating or sharing a COT. An indication of a CPE in a shared COT may be associated with the second criterion.

A CPE may be transmitted from a CPE starting position before a sidelink transmission within a COT. The CPE may be transmitted within a symbol before a next automatic gain control (AGC) symbol (e.g., for COT sharing). The CPE may be transmitted within at most 1, 2 or 4 symbols before a next AGC symbol for a 15, 30 or 60 kHz subcarrier spacing (SCS), respectively (e.g., when initiating a COT). Various channel access type(s) may be applicable.

A single CPE starting position may be defined for a physical sidelink feedback channel (PSFCH). A CPE starting position may be defined, and the CPE starting position may be preconfigured in each resource pool, predefined, or indicated in accordance with an indication granularity. At least one CPE starting position may be defined for a sidelink synchronization signal block (S-SSB) and for additional S-SSBs. A CPE starting position may be defined, and the CPE starting position may be preconfigured in each resource pool, predefined, or indicated. One or multiple CPE starting positions may be preconfigured in each resource pool for a PSSCH or a PSCCH. When multiple CPE starting positions are preconfigured, criteria may be defined for selecting a default CPE starting position (e.g., a partial/full resource block set allocation, resource reservation information, and/or being within or outside of a COT). Criteria may be defined for selecting one of the multiple CPE starting positions (e.g., a priority level, a random selection by a UE from a preconfigured set of CPEs, a selection by the UE based at least in part on a channel access result, and/or a determination based at least in part on an indication from a COT initiating UE).

Multiple CPE starting positions may be supported for a PSCCH/PSSCH. A first criteria may be adopted to select a default value to improve frequency division multiplexing (FDM) (e.g., reservation, or a partial resource block allocation). A second criteria may be used to select among the multiple CPE starting positions (e.g., random or priority-based selection).

Different sidelink channel access procedures may be defined (e.g., Type 2A, 2B, or 2C). A Type 2A channel access procedure may be applicable to transmission(s) by a UE following transmission(s) by another UE for a gap ≥25 μs in a shared channel occupancy. Type 2A may be associated with another transmission by a UE (e.g., other than COT sharing). Type 2A may be used also for the case of a short control signaling transmission. A Type 2B channel access procedure may be applicable to transmission(s) by a UE following transmission(s) by another UE at least when a gap is 16 μs in a shared channel occupancy. Type 2B may be associated with the case when the gap is between 16 and 25 μs. Type 2B may be associated with another transmission by a UE (e.g., other than COT sharing). A Type 2C channel access procedure may be applicable to transmission(s) by a UE following transmission(s) by another UE for a gap≤16 μs in a shared channel occupancy and a duration of a corresponding transmission is at most 584 μs. Type 2C may be associated with another transmission by a UE (e.g., other than COT sharing). Type 2C may be used also for the case of a short control signaling transmission. In certain conditions (other than the gap), UEs may apply the Type 2A/2B/2C SL channel access procedures. In certain conditions, Type 2B or Type 2C may be applied in case of a gap of 16 μs.

A CPE window (e.g., a set of multiple CPEs) may be within one symbol, or may span one or two symbols. The CPE may be transmitted from the CPE starting position before the sidelink transmission. The CPE may be transmitted within the symbol before the next AGC symbol. The CPE may be transmitted within the symbol before the next AGC symbol for 15 kHz SCS. The CPE may be transmitted within at most 2 symbols before the next AGC symbol for 30 or 60 kHz SCS.

Inside COT and outside COT CPE sets may be preconfigured or predefined, and each set may be populated with a 1-symbol length for the CPE window or a 2-symbol length for the CPE window. For 15 kHz, 30 kHz, and 60 kHz SCSs, a set of CPE starting candidate position(s) for PSCCH/PSSCH may be preconfigured or predefined (e.g., to be down-selected) separately for transmissions within a COT and transmissions outside the COT. Each set of CPE starting candidate position(s) associated with the 1-symbol length for the CPE window or the 2-symbol length for the CPE window and each set of CPE starting candidate position(s) may include one or multiple starting position(s), depending on the pre-configuration or the predefinition (e.g., to be down-selected). The set(s) of CPE starting positions may be preconfigured or predefined per priority. Values may be defined for the preconfigured or predefined CPE starting candidate position(s) (including a default value) for each set, and the default value may be the same or different for different sets.

A framework for the PSSCH may be further refined for the case of initiating the COT. Two criteria may be based at least in part on a full/partial resource block set resource allocation and reservation information. Multiple CPE starting candidate positions may be preconfigured for a PSCCH/PSSCH transmission for the case of initiating the COT. For the partial resource block set resource allocation, the UE may select a CPE starting position according to a down-selection and according to the reservation information. The UE may select the CPE starting position based at least in part on a preconfigured default CPE starting position, or a highest priority among detected and transmitted reservations. Such behavior may be allowed for a full resource block set resource allocation. Other conditions may include a comparison of an energy detection threshold (EDT) and a measured energy associated an existing reservation. The use of reservation information may be conditioned on the existence of other technologies (e.g., NR-U). For the full resource block set resource allocation, a CPE starting position may be randomly selected among the one or multiple CPE starting candidate positions preconfigured per priority of the PSCCH/PSSCH transmission. Such behavior may be allowed for the partial resource block set resource allocation. The UE may only use the selected CPE starting position, or the UE may use a later CPE starting position(s) than a selected one (e.g., when failed or not finished). The use of the reservation information may be conditioned on the existence of other technologies (e.g., NR-U).

A CPE selection framework may be used for initiating a COT. The CPE selection framework may be used for the UE to autonomously select a CPE to transmit concurrently (potentially FDM) to other UEs, or TDM with other UEs. In NR-U, a network node may schedule the UE and indicate a channel access type (e.g., Type 2A, 2B, or 2C) and a CPE length. The network node may fully control a formation of the COT (e.g., TDM and FDM of UEs), which may ensure that gaps are relatively tight and a most suitable channel access is used. Type 2B and 2C channel access may be preferred because such channel access may be performed over a relatively short gap of 16 μs so that other devices (e.g., WiFi devices) cannot interfere. Type 2A channel access may have a longer measurement of 25 μs on a gap ≥25 μs. Further, the UE's CPE starting positions in the case of COT sharing may be predefined in NR-U.

In an SL-U, a UE that shares a COT with one or more other UEs cannot fully control forming the COT. For example, the UE cannot schedule other UEs. Due to this difference between NR-U and SL-U, channel access and CPE indication may or may not be supported in SL-U. Further, an applicability of Type 2A, 2B, and 2C channel accesses may be based at least in part on gaps (e.g., between an end of a COT initiator's transmission and a start of a responder's transmission). A responder UE may be unable to select a channel access, e.g., measure a gap. The responder UE may be unable to select the channel access type and CPE for the COT sharing case. Supporting an indication of the channel access type and the CPE from a COT initiator may be useful in this scenario.

In various aspects of techniques and apparatuses described herein, a COT initiating UE may provide COT-SI in a PSCCH transmission or in a PSSCH transmission. The COT-SI may indicate information about a specific shared COT region. The COT responding UE may receive the COT-SI. The COT-SI may indicate an offset and a duration associated with the shared COT region. The offset and the duration may provide time domain information of the shared COT region. The COT-SI may or may not indicate the channel access type and the CPE associated with the shared COT region. In some examples, when the COT-SI indicates the channel access type and the CPE, the COT responding UE may select the channel access type and the CPE indicated in the COT-SI. In some examples, the COT-SI may indicate a channel access type and a CPE, but the COT responding UE may select a different channel access type and/or a different CPE than indicated in the COT-SI. In some examples, when the COT-SI does not indicate any channel access type or CPE, the COT responding UE may autonomously select the channel access type and the CPE. In some aspects, irrespectively of whether the COT responding UE selects the channel access type or the CPE indicated by the COT-SI, or autonomously selects the channel access type and the CPE, the COT responding UE may use the selected channel access type and CPE to perform a sidelink transmission.

In some aspects, depending on an objective of the COT initiating UE, configuring the COT-SI to indicate the channel access type and/or the CPE may improve an overall performance of the COT responding UE. When the COT initiating UE forms the COT and different regions of the COT are allocated for different UEs, explicitly indicating the channel access type and the CPE may allow the COT responding UE to follow the COT initiating UE's coordination. By explicitly indicating the channel access type and the CPE, the COT initiating UE may ensure that a risk of collisions is minimized, thereby improving an overall performance for the COT responding UE. When the COT initiating UE opens up the COT for sharing without coordination, the COT initiating UE may not explicitly indicate the channel access type and the CPE. Rather, the COT responding UE may be better suited to autonomously select the channel access type and the CPE, and the COT responding UE may be better suited to independently resolve a potential collision (e.g., without input from the COT initiating UE). Depending on the objective of the COT initiating UE, the COT responding UE may be configured to support the different approaches.

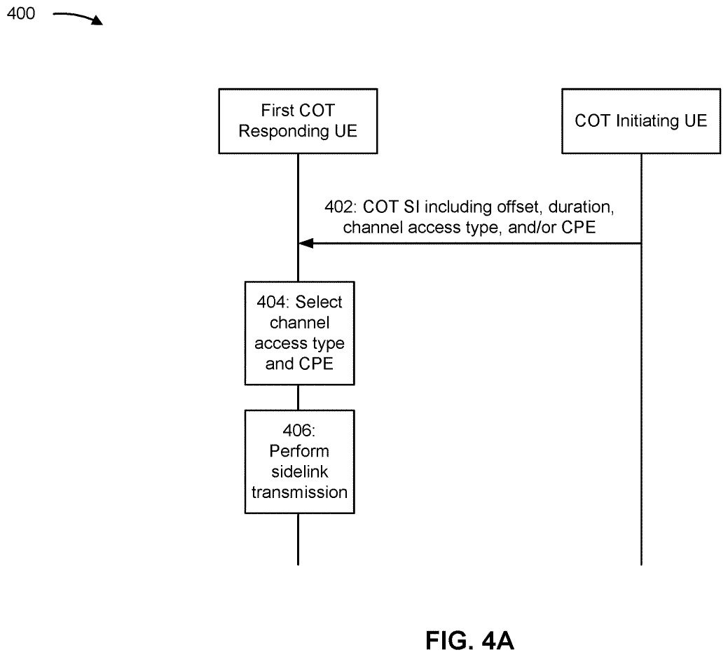

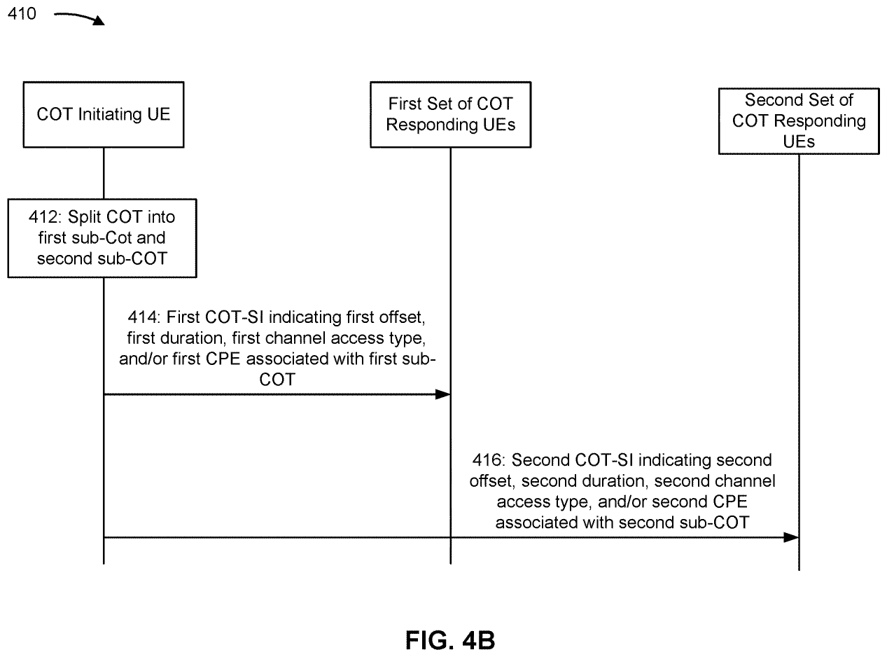

FIGS. 4A-4B are diagrams illustrating examples 400 associated with a CPE selection for a shared COT, in accordance with the present disclosure.

As shown in FIG. 4A, example 400 includes communication between a COT responding UE (e.g., UE 120a), and a COT initiating UE (e.g., UE 120e). In some aspects, the COT responding UE and the COT initiating UE may be included in a wireless network, such as wireless network 100. The COT responding UE may be a first UE and the COT initiating UE may be a second UE.

As shown by reference number 402, the COT responding UE may receive, from the COT initiating UE, COT-SI indicating information associated with a shared COT. The COT-SI may indicate an offset, a duration, the channel access type, and/or the CPE associated with the shared COT. The same COT-SI may be indicated to only the COT responding UE or to a group of COT responding UEs. In some aspects, the COT-SI may always indicate the offset and the duration, and the COT-SI may optionally indicate the channel access type and the CPE.

As shown by reference number 404, the COT responding UE may select a channel access type and a CPE based at least in part on the COT-SI. In some aspects, the COT-SI may indicate the channel access type and the CPE, and the COT responding UE may select the channel access type and the CPE based at least in part on the channel access type and the CPE indicated by the COT-SI. The COT responding UE may select the CPE based at least in part on the sidelink transmission occurring at a start of a slot indicated by an offset in the COT-SI. In some aspects, the COT-SI may indicate a first channel access type and a first CPE, and the COT responding UE, when selecting the channel access type and the CPE, may select a second channel access type and a second CPE based at least in part on an autonomous selection at the first UE. The COT responding UE may select the second CPE based at least in part on the sidelink transmission occurring after a start of a slot indicated by an offset in the COT-SI. The second channel access type may be a default channel access type, or the second channel access type may be an upgraded channel access type based at least in part on a received sidelink control information (SCI). In some aspects, the COT-SI may exclude the channel access type and the CPE, and the COT responding UE may select the channel access type and the CPE based at least in part on an autonomous selection at the first UE. The channel access type may be a default channel access type, or the channel access type may be an upgraded channel access type based at least in part on a received sidelink control information.

In some aspects, the COT responding UE may select the CPE based at least in part on an autonomous selection. The autonomous selection may include a random selection, a sidelink transmission priority based selection, or a random selection based at least in part on a sidelink transmission priority. In some aspects, the CPE may be associated with a first set of CPEs or a second set of CPEs, depending on whether the CPE is indicated by the COT-SI or selected autonomously at the first UE. In some aspects, the COT responding UE, when selecting the CPE, may select a default CPE from a set of CPEs. The default CPE may be selected based at least in part on the sidelink transmission being associated with a partial resource block set allocation. The default CPE may be selected based at least in part on a receipt of a reservation for a resource starting at a same starting slot associated with the sidelink transmission. The default CPE may be selected based at least in part on the first UE transmitting a reservation starting at a target slot associated with the sidelink transmission. The default CPE may be predefined in a specification, configured for the first UE, or indicated to the first UE via sidelink control information. The set of CPEs may include one or more prohibited CPEs. The one or more prohibited CPEs may be predefined in a specification or configured for the first UE. The one or more prohibited CPEs may be based at least in part on a detection of another UE transmission.

In some aspects, the COT responding UE may receive, from the COT initiating UE, COT-SI indicating at least an offset, a channel access type, and a CPE associated with a shared COT. The COT responding UE may select the channel access type and the CPE, as indicated by the COT-SI, based at least in part on a sidelink transmission to be transmitted at the offset. The COT responding UE may select the CPE based at least in part on the sidelink transmission occurring at a start of a slot indicated by the offset in the COT-SI. The CPE may be associated with a first set of CPEs based at least in part on the CPE being indicated by the COT-SI.

In some aspects, the COT responding UE may receive, from the COT initiating UE, COT-SI indicating at least an offset, a first channel access type, and a first CPE associated with a shared COT. The COT responding UE may select, in an autonomous manner, a second channel access type and a second CPE, different or same from the first channel access type and the second CPE indicated by the COT-SI, based at least in part on a sidelink transmission to be transmitted after the offset. The COT responding UE may select the second CPE based at least in part on the sidelink transmission occurring after a start of a slot indicated by the offset in the COT-SI.

In some aspects, the second channel access type may be a default channel access type, or the second channel access type may be an upgraded channel access type based at least in part on detecting another sidelink transmission from the second UE or a third UE in a slot prior to the sidelink transmission. The detection of another sidelink transmission may be based at least in part on a received SCI.

In some aspects, the COT responding UE may select the second CPE based at least in part on an autonomous selection and may include one of: a random selection, a sidelink transmission priority based selection, or a random selection based at least in part on a sidelink transmission priority. The CPE may be associated with a second set of CPEs based at least in part on the CPE being selected autonomously at the first UE.

In some aspects, the COT responding UE may receive, from the COT initiating UE, COT-SI associated with a shared COT. The COT responding UE may select a channel access type and a CPE in an autonomous manner based at least in part on the channel access type and the CPE being excluded from the COT-SI.

In some aspects, the COT responding UE may select the default CPE from the set of CPEs. The default CPE may be selected based at least in part on the sidelink transmission being associated with a partial resource block set allocation. The default CPE may be selected based at least in part on a receipt of a reservation message from a third UE for a resource starting at a same starting slot associated with the sidelink transmission. The default CPE may be selected based at least in part on the first UE transmitting a reservation message associated with the sidelink transmission. The default CPE may be predefined in a specification, configured for the first UE, or indicated to the first UE via sidelink control information. The set of CPEs may include one or more prohibited CPEs. The one or more prohibited CPEs may be predefined in a specification or configured for the first UE. The one or more prohibited CPEs may be based at least in part on a detection of another UE transmission.

As shown by reference number 406, the COT responding UE may perform a sidelink transmission based at least in part on the channel access type and the CPE, irrespective of whether the channel access type and the CPE are selected based at least in part on the COT-SI or autonomously selected by the COT responding UE. The COT responding UE may perform the sidelink transmission within the shared COT based at least in part on an outcome of a channel access procedure and the CPE. Further, the COT responding UE may perform the sidelink transmission based at least in part on the offset and the duration, as indicated by the COT-SI. The sidelink transmission may not necessarily be to the COT initiating UE, but rather may be to a different UE (e.g., a third UE).

As shown in FIG. 4B, example 410 includes communication between a COT initiating UE (e.g., UE 120e), a first set of COT responding UEs (e.g., UE 120a), and a second set of COT responding UEs (e.g., UE 120b). In some aspects, the COT initiating UE, the first set of COT responding UEs, and the second set of COT responding UEs may be included in a wireless network, such as wireless network 100.

As shown by reference number 412, the COT initiating UE may split a COT into a plurality of sub-COTs, which may include a first sub-COT and a second sub-COT. The COT initiating UE may form a COT based at least in part on a concatenation of different regions, which may correspond to the plurality of sub-COTs.

As shown by reference number 414, the COT initiating UE may transmit, to a first set of COT responding UEs, a first COT-SI that indicates at least a first offset and a first duration associated with the first sub-COT. The first COT-SI may additionally indicate a first channel access type and/or a first CPE. The first set of COT responding UEs may include one or more UEs.

As shown by reference number 416, the COT initiating UE may transmit, to a second set of COT responding UEs, a second COT-SI that indicates at least a second offset and a second duration associated with the second sub-COT. The second COT-SI may additionally indicate a second channel access type and/or a second CPE. The second set of COT responding UEs may include one or more UEs.

As indicated above, FIGS. 4A-4B are provided as examples. Other examples may differ from what is described with regard to FIGS. 4A-4B.

In some aspects, for COT sharing, two scenarios may be identified. A first scenario may be associated with an uncoordinated COT sharing. An initiator UE may not coordinate responder UE transmissions. A framework may involve no channel access and CPE indication, a first criterion to select a default CPE for concurrent transmissions, and a second criterion to select one CPE from a set of multiple to TDM and resolve collisions via different CPEs across UEs. A second scenario may be associated with a coordinated COT sharing. The initiator UE may coordinate responder UE transmissions (for example, based on received resource reservations in sidelink control information part 1 (SCI-1)). A framework may involve the initiator UE indicating a channel access type and a CPE to the responder UE.

In some aspects, in SL-U, no scheduling of the responder UE from the initiator UE may be present. For example, when Type 2C and CPE after a gap of 16 μs is indicated, but the responder UE intends to transmit after a relatively large gap (e.g., only Type 2A is applicable), then the indication may not be used by the responder UE. When the indication is supported in SL-U, a criterion may be needed to determine when the indication is followed, and criterion may be needed to determine when the channel access type and the CPE should be selected.

In some aspects, in a framework for CPE selection for the COT sharing case, an indication may be used in some scenarios. Otherwise, the UE may autonomously select the channel access type and the CPE.

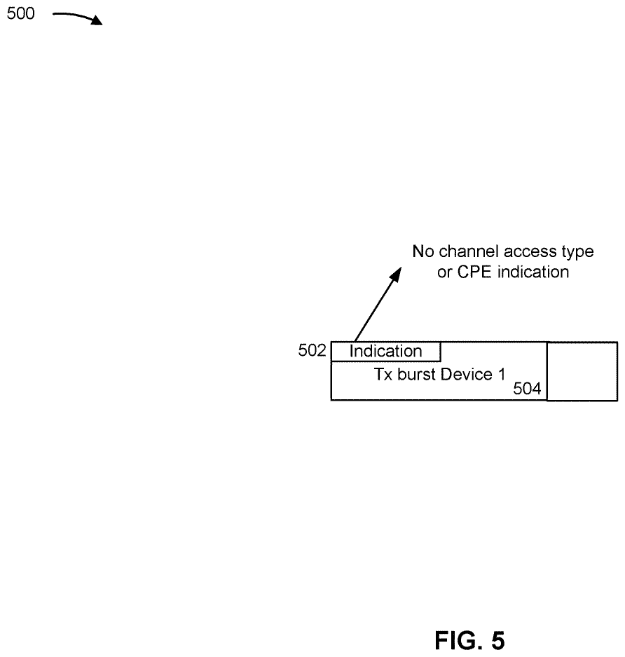

FIG. 5 is a diagram illustrating an example 500 associated with a CPE selection for a shared COT, in accordance with the present disclosure.

In some aspects, in uncoordinated COT sharing, a COT initiating UE (first device) may not coordinate with transmissions from COT responding UEs. As shown by reference number 502, the COT initiating device may transmit an indication, which may not indicate a channel access type or a CPE. Alternatively, the COT initiating device may not transmit any indication. As shown by reference number 504, the COT initiating UE may perform a transmission (Tx) burst during a COT.

As indicated above, FIG. 5 is provided as an example. Other examples may differ from what is described with regard to FIG. 5.

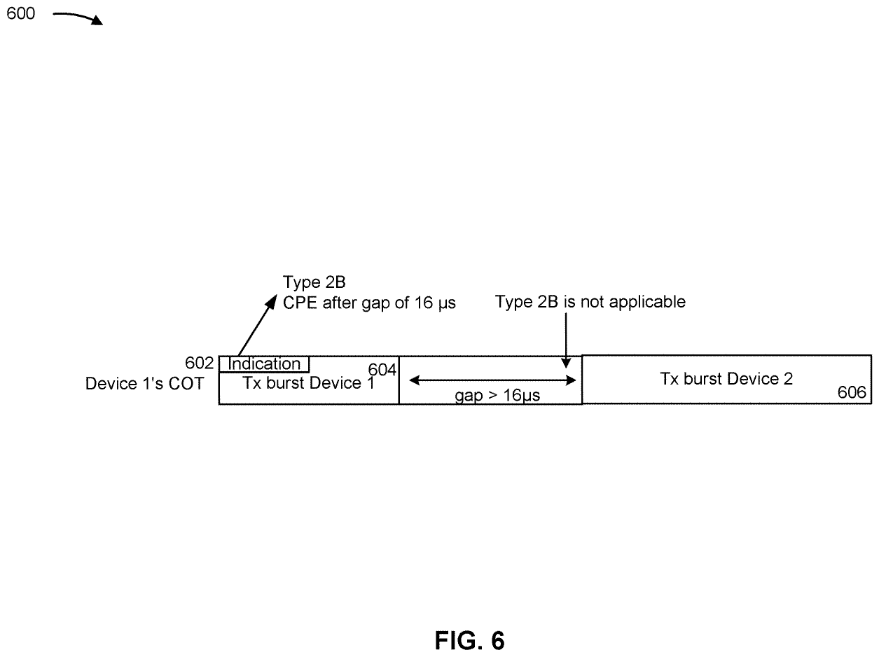

FIG. 6 is a diagram illustrating an example 600 associated with a CPE selection for a shared COT, in accordance with the present disclosure.

In some aspects, in coordinated COT sharing, a COT initiating UE (first device) may coordinate with transmissions from a COT responding UE (second device). As shown by reference number 602, the COT initiating device may transmit an indication, which may indicate a channel access type and a CPE. For example, the indication may indicate Type 2B and a CPE that is after a gap of 16 μs. As shown by reference number 604, the COT initiating UE may perform a Tx burst during a COT. At an end of a gap that is greater than 16 μs, Type 2B may no longer be applicable to the COT responding UE. As shown by reference number 606, the COT responding UE may perform a Tx burst, but not by using the channel access type and the CPE indicated by the COT initiating device.

As indicated above, FIG. 6 is provided as an example. Other examples may differ from what is described with regard to FIG. 6.

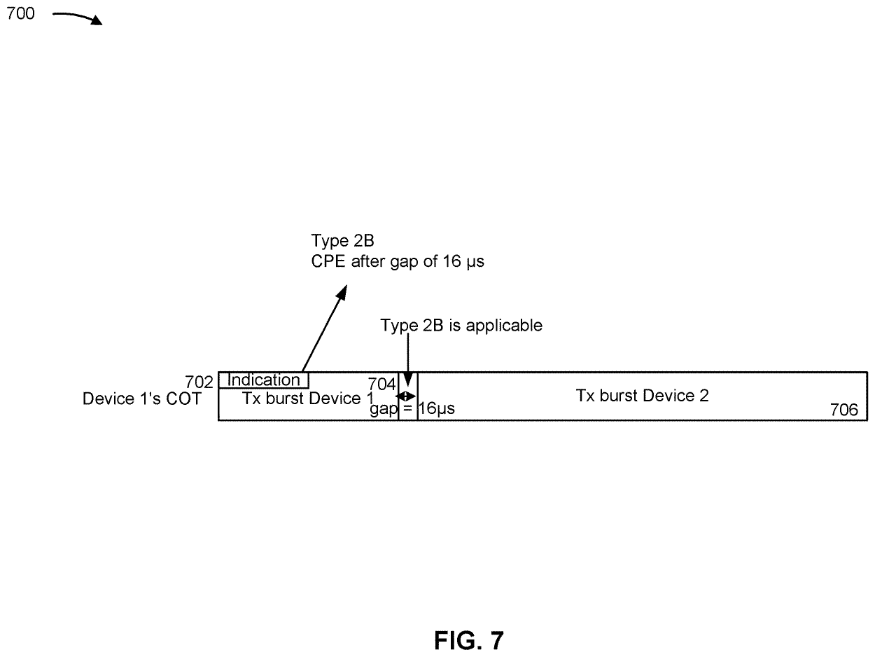

FIG. 7 is a diagram illustrating an example 700 associated with a CPE selection for a shared COT, in accordance with the present disclosure.

In a coordinated COT sharing, a COT initiating UE (first device) may coordinate with transmissions from a COT responding UE (second device). As shown by reference number 702, the COT initiating device may transmit an indication, which may indicate a channel access type and a CPE. For example, the indication may indicate Type 2B and a CPE that is after a gap of 16 μs. As shown by reference number 704, the COT initiating UE may perform a Tx burst during a COT. At an end of a gap that is equal to 16 μs, Type 2B may be applicable to the COT responding UE. As shown by reference number 706, the COT responding UE may perform a Tx burst, which may be based at least in part on the channel access type and the CPE indicated by the COT initiating device.

As indicated above, FIG. 7 is provided as an example. Other examples may differ from what is described with regard to FIG. 7.

In some aspects, a CPE selection in a shared COT may be based at least in part on the use of a channel access type and a CPE indication in COT-SI, and based at least in part on an autonomous selection of the CPE. In an NR-U UE-to-network-node COT sharing framework, a UE may use a codepoint in a configured grant uplink control information (CG-UCI) to indicate the COT-SI including an offset and a duration of a shared region. In this way, the UE that initiate a COT may delimit the shared region in the time domain. In some aspects, offset information may be incorporated in SL-U COT-SI, and the offset information may be used to inform a responder UE that a CPE indication is valid when a transmission start is targeting a slot indicated by an offset. Otherwise, another selection approach may be applied. A COT initiating device may be responsible to correctly indicate the channel access type and the CPE according to channel access applicability rules, by considering an (indicated) location in the time domain of the shared region relatively to an end of transmissions of the COT initiating device. A framework for COT sharing may be defined, in which time domain information of the shared COT may be provided in SL-U.

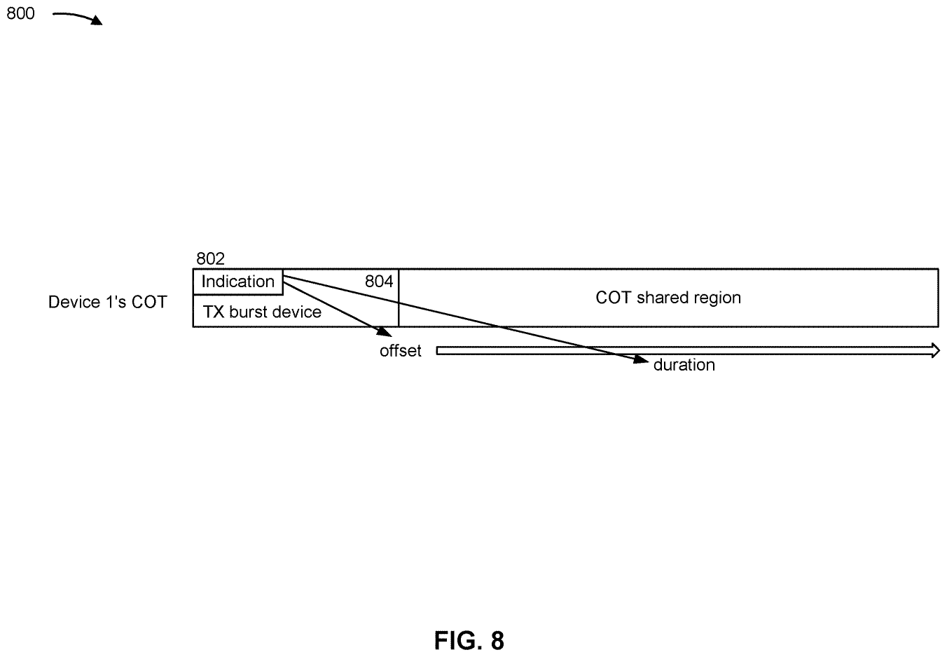

FIG. 8 is a diagram illustrating an example 800 associated with a CPE selection for a shared COT, in accordance with the present disclosure.

As shown by reference number 802, a COT initiating UE (first device) may transmit an indication, which may indicate a channel access type and a CPE. The indication may also indicate an offset and a duration. The offset may indicate an end of the COT initiating UE's Tx burst and/or a start of a COT shared region. The duration may indicate a time period associated with the COT shared region. The offset may indicate to a COT responding UE that the channel access type and the CPE are valid when the COT responding UE's Tx start is targeting a slot indicated by the offset. As shown by reference number 804, the COT responding UE may perform a Tx burst, which may be based at least in part on the channel access type, the CPE, the offset, and the duration indicated by the COT initiating device.

As indicated above, FIG. 8 is provided as an example. Other examples may differ from what is described with regard to FIG. 8.

In some aspects, at least one set of CPE positions for a COT sharing case (e.g., inside COT) may be available (e.g., predefined or preconfigured). A second set of CPE positions may also be available. The second set may or may not be supported. In some aspects, time domain information of a shared COT region may be provided in COT-SI via an offset and a duration parameter. In some aspects, a channel access type and a CPE may be indicated in the COT-SI via a codepoint.

In some aspects, a COT initiating UE may indicate a special slot in which a COT responding UE may follow a channel access and a CPE (e.g., the CPE may be within a first set). The channel access and the CPE may be indicated by the COT initiating UE to the COT responding UE. For example, the COT initiating UE may transmit a first indication that indicates a Type 2B or 2C, a CPE for a gap equal to 16 μs in a symbol 13, and an offset. The COT initiating UE may transmit a second indication that indicates a Type 2A, a CPE for a gap equal to 25 μs in a symbol 13, and an offset. A COT responding UE may use the first indication or the second indication when the COT responding UE intends to perform a transmission immediately after an offset. Otherwise, the COT responding UE may use Type 2A and may autonomously determine the CPE in a preconfigured inside COT set (e.g., the COT responding UE may use a second set).

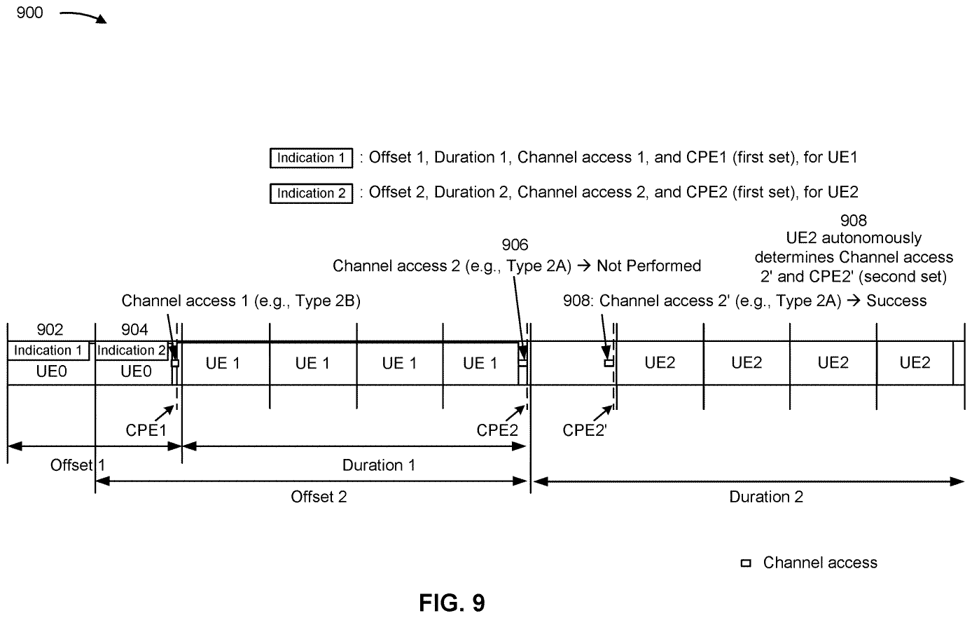

FIG. 9 is a diagram illustrating an example 900 associated with a CPE selection for a shared COT, in accordance with the present disclosure.

As shown by reference number 902, a COT initiating UE (UE0) may transmit a first indication, which may be received by a first COT responding UE (UE1). The first indication may indicate a first offset, a first duration, a first channel access (e.g., Type 2B), and a first CPE (first set) for the first COT responding UE. The first COT responding UE may perform a first transmission during a time period based at least in part on the first offset, the first duration, the first channel access, and the first CPE. As shown by reference number 904, the COT initiating UE may transmit a second indication, which may be received by a second COT responding UE (UE2). The second indication may indicate a second offset, a second duration, a second channel access (e.g., Type 2A), and a second CPE (first set) for the second COT responding UE. As shown by reference number 906, the second COT responding UE may determine to not perform a second transmission during a time period based at least in part on the second offset, the second duration, the second channel access, and the second CPE. For example, the second COT responding UE may not perform the second channel access and not use the second CPE at an end of the second offset. Rather, the second COT responding UE may determine to perform the second transmission at a later point in time (e.g., within the second duration), for which the second COT responding UE may autonomously determine a channel access type and a CPE (as shown by reference number 908).

As indicated above, FIG. 9 is provided as an example. Other examples may differ from what is described with regard to FIG. 9.

In some aspects, a behavior of a COT initiating UE (e.g., a second UE) and a COT responding UE (e.g., a first UE) may be defined. In some aspects, the COT initiating UE may provide a COT-SI in each of its PSCCH/PSSCH transmissions, where each COT-SI may target a specific UE (or set of UEs). The COT-SI may provide information about a specific shared COT region. The COT initiating UE may provide multiple COT-SIs across different PSCCH/PSSCH transmissions (e.g., one COT-SI per each COT initiating UE's PSCCH/PSSCH transmission).

In some aspects, the COT responding UE may receive COT-SI from the COT initiating UE. In some aspects, a channel access type and a CPE may be indicated by the COT initiating UE. The COT responding UE may select an indicated CPE from a set (e.g., a first set) and an indicated channel access type when the COT responding UE targets starting transmission(s) at a start of a slot indicated by an offset parameter. The COT responding UE may select (e.g., autonomously) another CPE from the set (or a second set) and Type 2A channel access when the COT responding UE targets starting transmission(s) after the start of the slot indicated by the offset parameter (e.g., in a second sidelink starting symbol, or in a later slot). The COT responding UE may autonomously select the CPE in the set using one or multiple approaches.

In some aspects, the COT responding UE may select the indicated CPE or another CPE when the COT initiating UE forms the COT (e.g., using a coordinated COT sharing). Different regions may be allocated for different set of UEs (e.g., potentially one UE per region), and the COT responding UEs may attempt to comply with the COT initiating UE's coordination. The COT initiating UE may resolve collisions in a region. For example, the COT initiating UE may assign different CPEs to different UEs, or the COT initiating UE may assign a region to UEs that do not have collisions (e.g., using FDM) in its implementation.

In some aspects, the channel access type and the CPE may not be indicated by the COT initiating UE. The COT responding UE may select (e.g., autonomously) the CPE from a set (e.g., a second set) and the channel access type. Type 2A may be a default channel access. Type 2B or 2C may be used (e.g., as an upgrade) when the COT responding UE is able to detect (e.g., via an SCI information parsing) that the COT initiating UE terminated its transmission in a previous slot, and when a selected CPE may ensure a gap of 16 μs from an end of the COT initiating UE's termination.

In some aspects, the COT responding UE may autonomously select the CPE when the COT initiating UE initiates a COT for sharing, without attempting to coordinate the COT responding UE (e.g., using an uncoordinated COT sharing). For example, when the COT initiating UE shares the COT with a single indication to a set of COT responding UEs without knowing their resource allocations, the COT responding UE may be better suited to autonomously select the channel access type and the CPE. The COT responding UE may need to resolve collisions via the CPE.

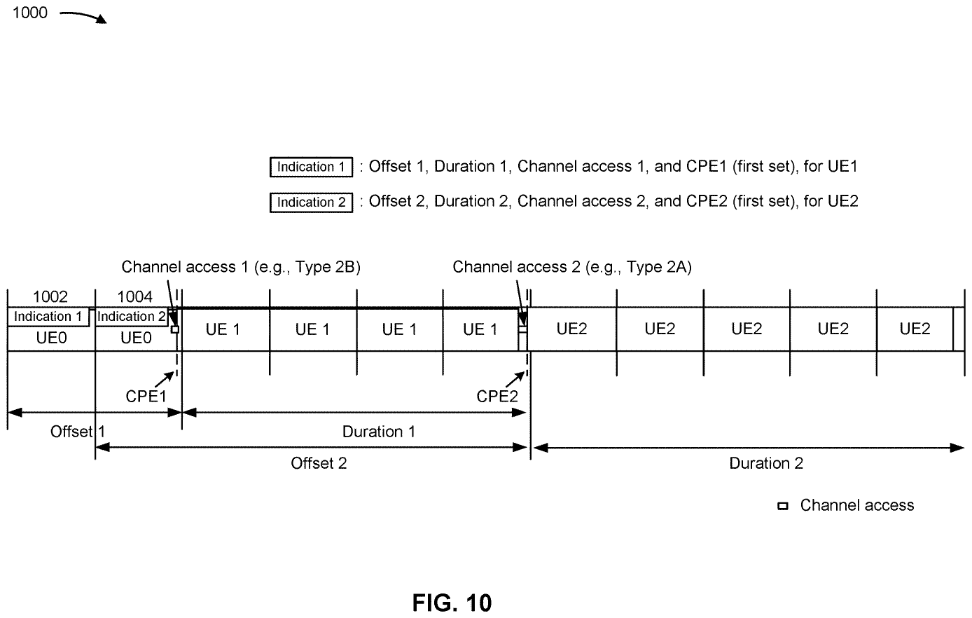

FIG. 10 is a diagram illustrating an example 1000 associated with a CPE selection for a shared COT, in accordance with the present disclosure.

As shown by reference number 1002, for time division multiplexed UEs, a COT initiating UE (UE0) may transmit a first indication, which may be received by a first COT responding UE (UE1). The first indication may indicate a first offset, a first duration, a first channel access (e.g., Type 2B), and a first CPE (first set) for the first COT responding UE. The first COT responding UE may perform a first transmission during a time period based at least in part on the first offset, the first duration, the first channel access, and the first CPE. As shown by reference number 1004, the COT initiating UE may transmit a second indication, which may be received by a second COT responding UE (UE2). The second indication may indicate a second offset, a second duration, a second channel access (e.g., Type 2A), and a second CPE (first set) for the second COT responding UE. The second COT responding UE may perform a second transmission during a time period based at least in part on the second offset, the second duration, the second channel access, and the second CPE, where the second transmission may be time division multiplexed with the first transmission.

As indicated above, FIG. 10 is provided as an example. Other examples may differ from what is described with regard to FIG. 10.

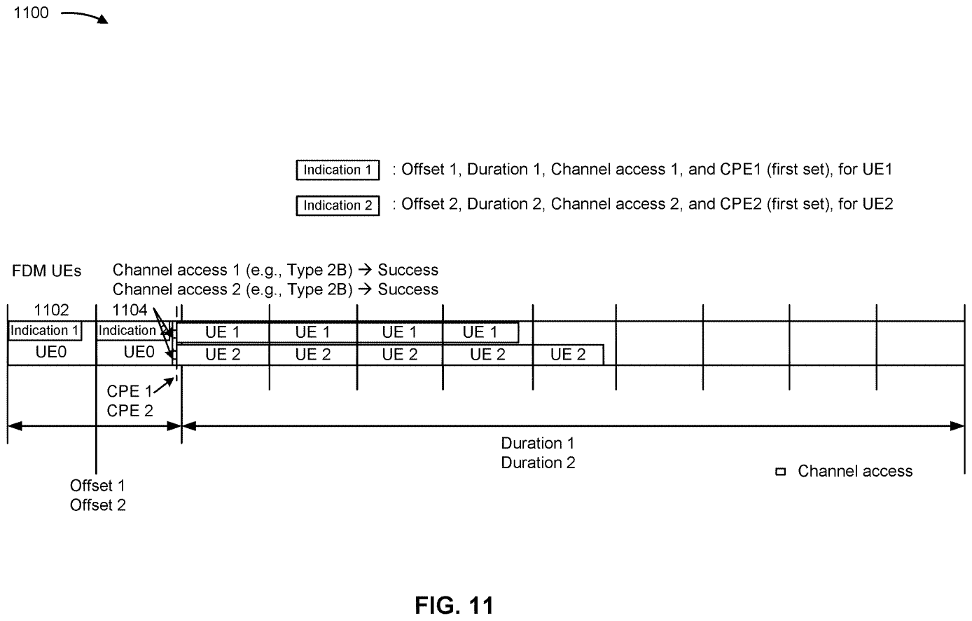

FIG. 11 is a diagram illustrating an example 1100 associated with a CPE selection for a shared COT, in accordance with the present disclosure.

As shown by reference number 1102, for frequency division multiplexed UEs, a COT initiating UE (UE0) may transmit a first indication, which may be received by a first COT responding UE (UE1). The first indication may indicate a first offset, a first duration, a first channel access (e.g., Type 2B), and a first CPE (first set) for the first COT responding UE. The first COT responding UE may perform a first transmission during a time period based at least in part on the first offset, the first duration, the first channel access (e.g., Type 2B may be successful), and the first CPE. As shown by reference number 1104, the COT initiating UE may transmit a second indication, which may be received by a second COT responding UE (UE2). The second indication may indicate a second offset, a second duration, a second channel access (e.g., Type 2B), and a second CPE (first set) for the second COT responding UE. The second offset, the second duration, the second channel access, and/or the second CPE may be the same as the first offset, the first duration, the first channel access, and/or the first CPE, respectively. The second COT responding UE may perform a second transmission during a time period based at least in part on the second offset, the second duration, the second channel access (e.g., Type 2B may be successful), and the second CPE, where the second transmission may be frequency division multiplexed with the first transmission.

As indicated above, FIG. 11 is provided as an example. Other examples may differ from what is described with regard to FIG. 11.

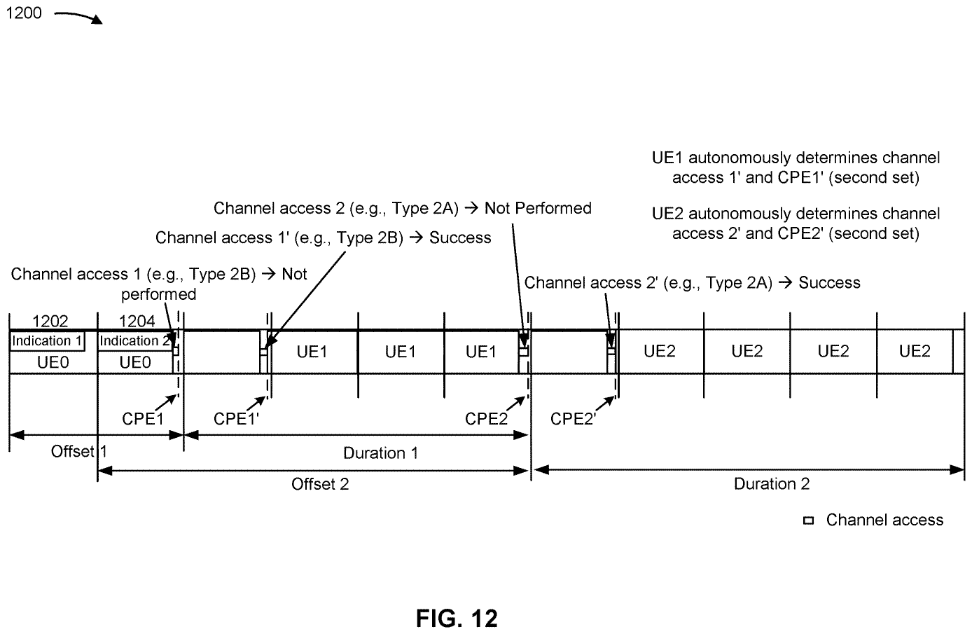

FIG. 12 is a diagram illustrating an example 1200 associated with a CPE selection for a shared COT, in accordance with the present disclosure.

As shown by reference number 1202, a COT initiating UE (UE0) may transmit a first indication, which may be received by a first COT responding UE (UE1). The first indication may indicate a first offset, a first duration, a first channel access (e.g., Type 2B), and a first CPE (first set) for the first COT responding UE. The first COT responding UE may determine to not perform a first transmission during a time period based at least in part on the first offset, the first duration, the first channel access, and the first CPE. For example, the first COT responding UE may not perform the first channel access and not use the first CPE at an end of the first offset. Rather, the first COT responding UE may determine to perform the first transmission at a later point in time (e.g., within the first duration), for which the first COT responding UE may autonomously determine a channel access type and a CPE (which may or may not be the same as the first channel access type and the first CPE).

As shown by reference number 1204, the COT initiating UE may transmit a second indication, which may be received by a second COT responding UE (UE2). The second indication may indicate a second offset, a second duration, a second channel access (e.g., Type 2A), and a second CPE (first set) for the second COT responding UE. The second COT responding UE may determine to not perform a second transmission during a time period based at least in part on the second offset, the second duration, the second channel access, and the second CPE. For example, the second COT responding UE may not perform the second channel access and not use the second CPE at an end of the second offset. Rather, the second COT responding UE may determine to perform the second transmission at a later point in time (e.g., within the second duration), for which the second COT responding UE may autonomously determine a channel access type and a CPE (which may or may not be the same as the second channel access type and the second CPE).

As indicated above, FIG. 12 is provided as an example. Other examples may differ from what is described with regard to FIG. 12.

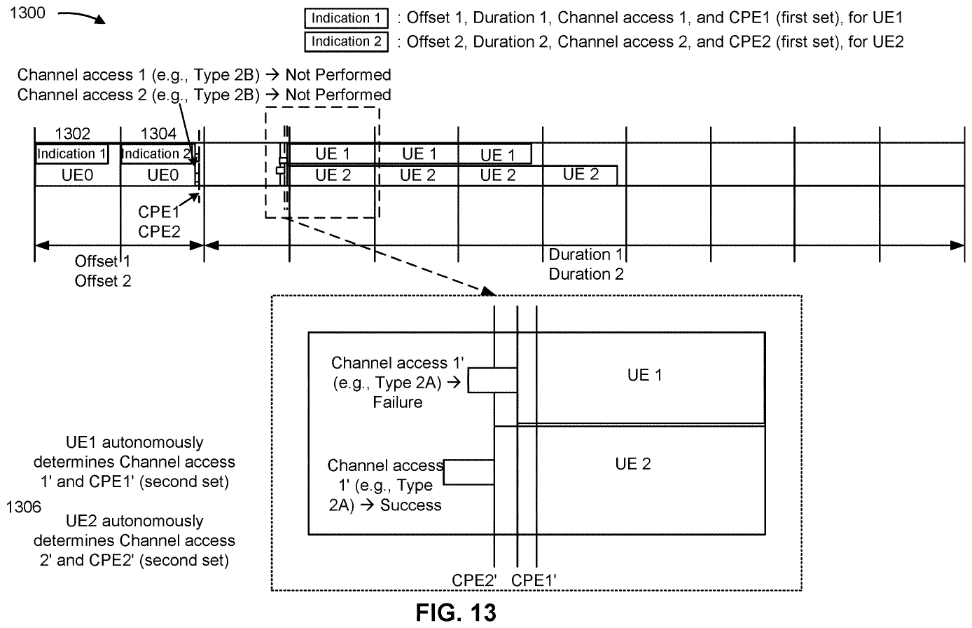

FIG. 13 is a diagram illustrating an example 1300 associated with a CPE selection for a shared COT, in accordance with the present disclosure.

As shown by reference number 1302, for frequency division multiplexed UEs, a COT initiating UE (UE0) may transmit a first indication, which may be received by a first COT responding UE (UE1). The first indication may indicate a first offset, a first duration, a first channel access (e.g., Type 2B), and a first CPE (first set) for the first COT responding UE. As shown by reference number 1304, COT initiating UE may transmit a second indication, which may be received by a second COT responding UE (UE2). The second indication may indicate a second offset, a second duration, a second channel access (e.g., Type 2B), and a second CPE (first set) for the second COT responding UE. The second offset, the second duration, the second channel access, and/or the second CPE may be the same as the first offset, the first duration, the first channel access, and/or the first CPE, respectively.

The first COT responding UE and the second COT responding UE may determine to not perform a first transmission and a second transmission, respectively, immediately before the first offset and the second offset, respectively. Rather, as shown by reference number 1306, the first COT responding UE and the second COT responding UE may determine to perform the first transmission and the second transmission, respectively, at a later point in time (e.g., within the first duration and the second duration). The first COT responding UE may autonomously determine a channel access type (e.g., Type 2A) and a CPE, which may be associated with a failure. The second COT responding UE may autonomously determine a channel access type (e.g., Type 2A) and a CPE, which may be associated with a success.

As indicated above, FIG. 13 is provided as an example. Other examples may differ from what is described with regard to FIG. 13.

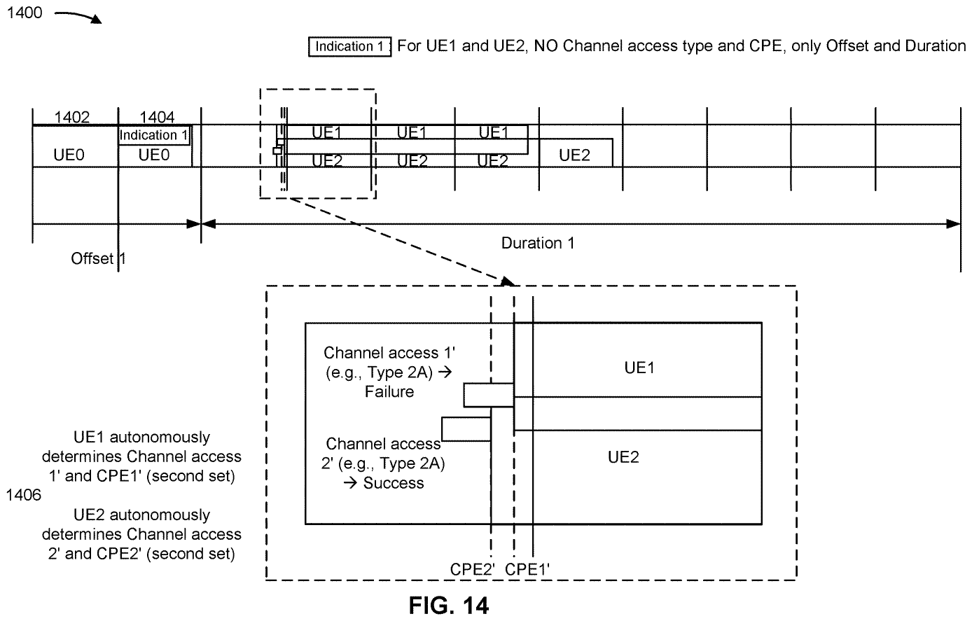

FIG. 14 is a diagram illustrating an example 1400 associated with a CPE selection for a shared COT, in accordance with the present disclosure.

As shown by reference number 1402, for frequency division multiplexed UEs, a COT initiating UE (UE0) may transmit a first indication, which may be received by a first COT responding UE (UE1). The first indication may indicate a first offset and a first duration. The first indication may not indicate a first channel access and a first CPE. As shown by reference number 1404, the COT initiating UE may transmit a second indication, which may be received by a second COT responding UE (UE2). The second indication may indicate a second offset and a second duration. The second indication may not indicate a second channel access and a second CPE. The second offset and the second duration may be the same as the first offset and the first duration, respectively.

The first COT responding UE and the second COT responding UE may determine to not perform a first transmission and a second transmission, respectively, immediately before the first offset and the second offset, respectively. Rather, as shown by reference number 1406, the first COT responding UE and the second COT responding UE may determine to perform the first transmission and the second transmission, respectively, at a later point in time (e.g., within the first duration and the second duration). The first COT responding UE may autonomously determine a channel access type (e.g., Type 2A) and a CPE, which may be associated with a failure. The second COT responding UE may autonomously determine a channel access type (e.g., Type 2A) and a CPE, which may be associated with a success.

As indicated above, FIG. 14 is provided as an example. Other examples may differ from what is described with regard to FIG. 14.

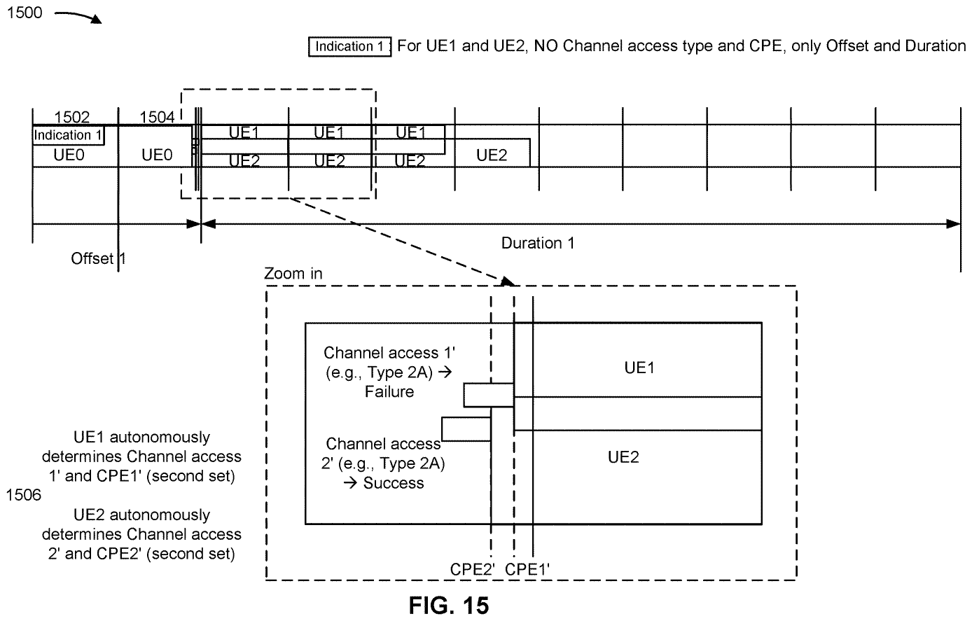

FIG. 15 is a diagram illustrating an example 1500 associated with a CPE selection for a shared COT, in accordance with the present disclosure.

As shown by reference number 1502, for frequency division multiplexed UEs, a COT initiating UE (UE0) may transmit a first indication, which may be received by a first COT responding UE (UE1). The first indication may indicate a first offset and a first duration. The first indication may not indicate a first channel access and a first CPE. As shown by reference number 1504, the COT initiating UE may transmit a second indication, which may be received by a second COT responding UE (UE2). The second indication may indicate a second offset and a second duration. The second indication may not indicate a second channel access and a second CPE. The second offset and the second duration may be the same as the first offset and the first duration, respectively.

The first COT responding UE and the second COT responding UE may determine to not perform a first transmission and a second transmission, respectively, immediately before the first offset and the second offset, respectively. Rather, as shown by reference number 1506, the first COT responding UE and the second COT responding UE may determine to perform the first transmission and the second transmission, respectively, at a later point in time (e.g., within the first duration and the second duration). The first COT responding UE may autonomously determine a channel access type (e.g., Type 2A) and a CPE, which may be associated with a failure. The second COT responding UE may autonomously determine a channel access type (e.g., Type 2B) and a CPE, which may be associated with a success. The second COT responding UE may be able to use Type 2B or 2C when the second COT responding UE is able to detect (e.g., via SCI information parsing) that the COT initiating UE terminated its transmission in a previous slot.

As indicated above, FIG. 15 is provided as an example. Other examples may differ from what is described with regard to FIG. 15.

In some aspects, a COT responding UE may perform an autonomous CPE determination in a shared COT. The COT responding UE ma select a CPE position in a set when an indication is absent or cannot be used. When the indication is absent or cannot be used, the COT responding UE may select the CPE (or the CPE position in the set) using one of three options. In a first option, the COT responding UE may select the CPE at random. In a second option, the COT responding UE may select the CPE associated with a transmission priority (e.g., a channel access priority class (CAPC) or a layer 1 (L1) priority). In a third option, the COT responding UE may select at random one of the CPEs associated with the transmission priority (e.g., CAPC or L1 priority).

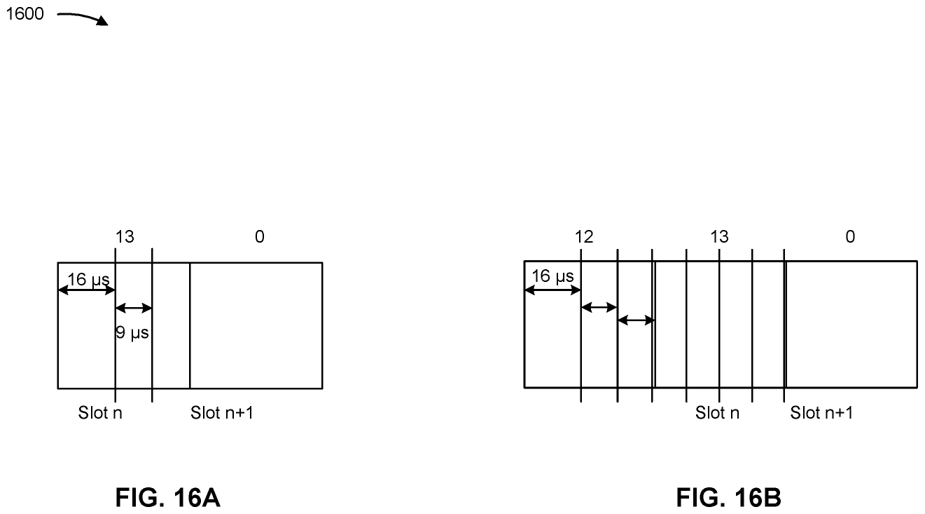

FIGS. 16A-16B are diagrams illustrating examples 1600 associated with a CPE selection for a shared COT, in accordance with the present disclosure.

In some aspects, two different sets of CPEs may be used for an inside COT case. As shown by FIG. 16A, a first set may be associated with a channel access type and a CPE not being indicated by a COT initiating UE. The first set of CPEs may be preconfigured or predefined. The first set may be used with the indication of the channel access type and the CPE, and the first set may be predefined to indicate two CPE positions (e.g., 16 μs and 25 μs). As shown by FIG. 16B, a second set may be associated with an autonomous selection of another CPE from another set, and/or a non-receipt of the channel access type and the CPE from the COT initiating UE. The second set of CPEs may be preconfigured or predefined. The second set may be used for an autonomous selection of the CPE, and the second set may be preconfigured to be associated with collision resolution and/or a possibility of chaining UEs' transmissions.

As indicated above, FIGS. 16A-16B are provided as examples. Other examples may differ from what is described with regard to FIGS. 16A-16B.

In some aspects, a set of CPEs (e.g., the second set) may contain a default CPE position, which may be selected based at least in part on a criterion. In a first option, the set of CPEs may contain the default CPE position when a transmission has a partial resource block set allocation. In a second option, the set of CPEs may contain the default CPE position when a COT responding UE has communicated a reservation for resources starting at a target slot (e.g., an outgoing SCI-1) or when the COT responding UE has received a reservation (e.g., an incoming SCI-1) for a resource starting at the target slot. Additionally, when the COT responding UE has received an incoming reservation, the set of CPEs may contain the default CPE position when the transmission has the partial resource block set allocation. Additionally, when the COT responding UE has received an incoming reservation, the COT responding UE's own resources and resources reserved by the incoming reservation may be frequency division multiplexed.

In some aspects, the reservation may be for a different transmission in the same target slot from another UE. The resource starting at the target slot may be allocated to frequency division multiplex with the different transmission. The resource may be partially overlapped with the different transmission. The reservation of the different transmission may be associated with an RSRP level that is below a target RSRP level. The target RSRP level may be an RSRP level used for determining a resource exclusion in reevaluation and preemption checks. The reservation of the different transmission may be associated with an RSRP level above an EDT level.

In some aspects, the set of CPEs (e.g., the second set) may contain the default CPE position, which may be based at least in part on a predefinition in a specification, a pre-configuration, or a dynamic determination. For example, the default CPE position may be signaled in an SCI-1 reservation, in which case the UE that receives the SCI-1 reservation may follow the CPE indicated in the SCI-1 reservation. When additional reservations are received, and when a CPE selection is based at least in part on a priority, the COT responding UE may select the CPE associated with the highest priority among the received reservations. Additionally, the COT responding UE may consider its own outgoing reservation when available.

In some aspects, the set of CPEs (e.g., the second set) may contain one or more prohibited CPE positions, which may be predefined in the specification or preconfigured. For example, when the COT responding UE is associated with the autonomous selection of another CPE from another set, or when the COT responding UE does not receive an indication of the channel access type and the CPE, a relatively large gap is likely from an end of the COT initiating UE's transmission, so a position for Type 2B/2C with a 16 μs gap should be prohibited (when present in the set). In some cases, the COT responding UE may be able to determine that a response is after a short gap from an end of the COT initiating UE's transmission, in which case the CPE for the gap 16 μs should be selectable.

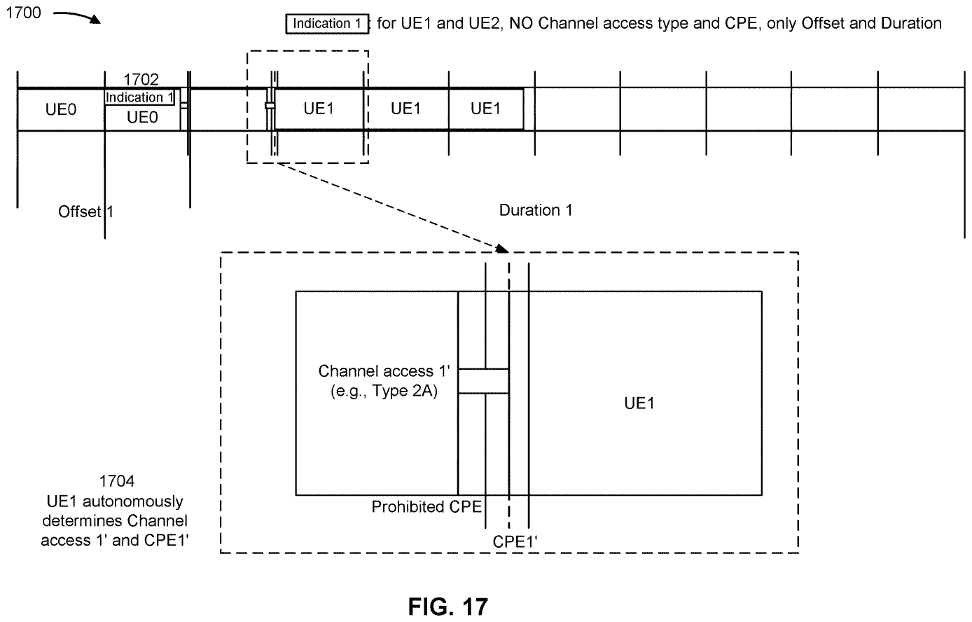

FIG. 17 is a diagram illustrating an example 1700 associated with a CPE selection for a shared COT, in accordance with the present disclosure.

As shown by reference number 1702, a COT initiating UE (UE0) may transmit a first indication, which may be received by a first COT responding UE (UE1). The first indication may indicate a first offset, a first duration, a first channel access, and a first CPE (first set) for the first COT responding UE. The first COT responding UE may determine to not perform a first transmission immediately after the first offset. Rather, the first COT responding UE may determine to perform the first transmission and the second transmission at a later point in time (e.g., within the first duration). As shown by reference number 1704, the first COT responding UE may autonomously determine a channel access type (e.g., Type 2A) and a CPE. The first COT responding UE may avoid selecting a prohibited CPE, which may be predefined in a specification or preconfigured.

As indicated above, FIG. 17 is provided as an example. Other examples may differ from what is described with regard to FIG. 17.

In some aspects, a CPE position may be prohibited based at least in part on a condition. The CPE position may be prohibited based at least in part on a detection that another UE is transmitting in a slot in which a CPE is supposed to be transmitted. For example, a set of CPEs may be defined based at least in part on a 2-symbol window. When a UE is transmitting in that slot, the UE may transmit over symbol #12, so every CPE in symbol #12 should be prohibited. A detection of another UE's transmission may be based at least in part on a detection of an SCI (e.g., in a slot in which the CPE is supposed to be transmitted, or on resource block set(s) over which the transmission is supposed to happen).

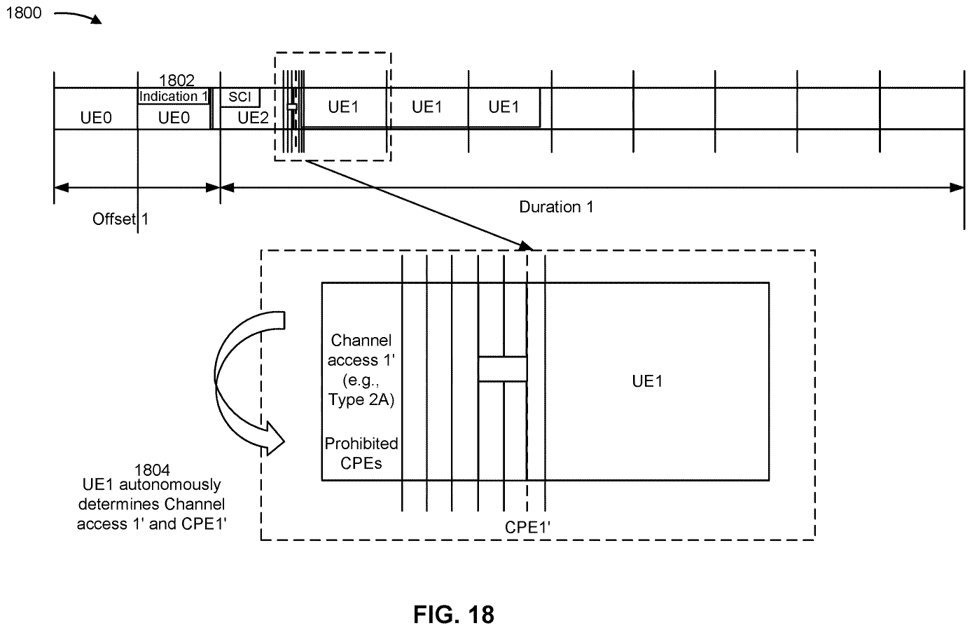

FIG. 18 is a diagram illustrating an example 1800 associated with a CPE selection for a shared COT, in accordance with the present disclosure.

As shown by reference number 1802, a COT initiating UE (UE0) may transmit a first indication, which may be received by a first COT responding UE (UE1). The first indication may indicate a first offset, a first duration, a first channel access, and a first CPE (first set) for the first COT responding UE. A second UE may transmit SCI in a slot within the first duration, where the SCI may be detected by the first COT responding UE. The first COT responding UE may determine that one or more CPEs associated with the slot are prohibited CPEs. As shown by reference number 1804, the first COT responding UE, when performing an autonomous selection of a channel access type and a CPE, may avoid selecting one of the prohibited CPEs.

As indicated above, FIG. 18 is provided as an example. Other examples may differ from what is described with regard to FIG. 18.

FIG. 19 is a diagram illustrating an example process 1900 performed, for example, by a first UE, in accordance with the present disclosure. Example process 1900 is an example where the first UE (e.g., UE 120a) performs operations associated with a CPE selection for a shared COT.

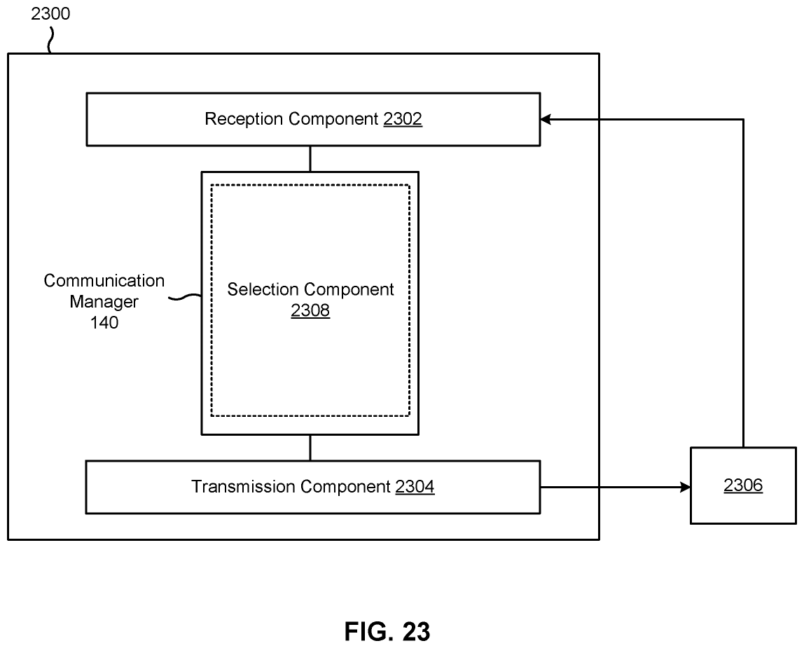

As shown in FIG. 19, in some aspects, process 1900 may include receiving, from a second UE, COT-SI indicating at least an offset, a channel access type, and a CPE associated with a shared COT (block 1910). For example, the first UE (e.g., using communication manager 140 and/or reception component 2302, depicted in FIG. 23) may receive, from a second UE, COT-SI indicating at least an offset, a channel access type, and a CPE associated with a shared COT, as described above.

As further shown in FIG. 19, in some aspects, process 1900 may include selecting the channel access type and the CPE, as indicated by the COT-SI, based at least in part on a sidelink transmission to be transmitted at the offset (block 1920). For example, the first UE (e.g., using communication manager 140 and/or selection component 2308, depicted in FIG. 23) may select the channel access type and the CPE, as indicated by the COT-SI, based at least in part on a sidelink transmission to be transmitted at the offset, as described above.

As further shown in FIG. 19, in some aspects, process 1900 may include performing the sidelink transmission within the shared COT based at least in part on an outcome of a channel access procedure and the CPE (block 1930). For example, the first UE (e.g., using communication manager 140 and/or performing component 2304, depicted in FIG. 23) may perform the sidelink transmission within the shared COT based at least in part on an outcome of a channel access procedure and the CPE, as described above.

Process 1900 may include additional aspects, such as any single aspect or any combination of aspects described below and/or in connection with one or more other processes described elsewhere herein.

In a first aspect, selecting the CPE is based at least in part on the sidelink transmission occurring at a start of a slot indicated by the offset in the COT-SI.

In a second aspect, alone or in combination with the first aspect, the CPE is associated with a first set of CPEs based at least in part on the CPE being indicated by the COT-SI.

In a third aspect, alone or in combination with one or more of the first and second aspects, the first UE is a COT responding UE.

In a fourth aspect, alone or in combination with one or more of the first through third aspects, the second UE is a COT initiating UE.

Although FIG. 19 shows example blocks of process 1900, in some aspects, process 1900 may include additional blocks, fewer blocks, different blocks, or differently arranged blocks than those depicted in FIG. 19. Additionally, or alternatively, two or more of the blocks of process 1900 may be performed in parallel.

FIG. 20 is a diagram illustrating an example process 2000 performed, for example, by a first UE, in accordance with the present disclosure. Example process 2000 is an example where the first UE (e.g., UE 120a) performs operations associated with a CPE selection for a shared COT.

As shown in FIG. 20, in some aspects, process 2000 may include receiving, from a second UE, COT-SI indicating at least an offset, a first channel access type, and a first CPE associated with a shared COT (block 2010). For example, the first UE (e.g., using communication manager 140 and/or reception component 2302, depicted in FIG. 23) may receive, from a second UE, COT-SI indicating at least an offset, a first channel access type, and a first CPE associated with a shared COT, as described above.

As further shown in FIG. 20, in some aspects, process 2000 may include selecting, in an autonomous manner, a second channel access type and a second CPE, different or same from the first channel access type and the second CPE indicated by the COT-SI, based at least in part on a sidelink transmission to be transmitted after the offset (block 2020). For example, the first UE (e.g., using communication manager 140 and/or selection component 2308, depicted in FIG. 23) may select, in an autonomous manner, a second channel access type and a second CPE, different or same from the first channel access type and the second CPE indicated by the COT-SI, based at least in part on a sidelink transmission to be transmitted after the offset, as described above.

As further shown in FIG. 20, in some aspects, process 2000 may include performing the sidelink transmission within the shared COT based at least in part on an outcome of a channel access procedure and the second CPE (block 2030). For example, the first UE (e.g., using communication manager 140 and/or performing component 2304, depicted in FIG. 23) may perform the sidelink transmission within the shared COT based at least in part on an outcome of a channel access procedure and the second CPE, as described above.

Process 2000 may include additional aspects, such as any single aspect or any combination of aspects described below and/or in connection with one or more other processes described elsewhere herein.

In a first aspect, selecting the second CPE is based at least in part on the sidelink transmission occurring after a start of a slot indicated by the offset in the COT-SI.

In a second aspect, alone or in combination with the first aspect, the second channel access type is a default channel access type, or the second channel access type is an upgraded channel access type based at least in part on detecting another sidelink transmission from the second UE or a third UE in a slot prior to the sidelink transmission.

In a third aspect, alone or in combination with one or more of the first and second aspects, detecting another sidelink transmission is based at least in part on a received sidelink control information.

In a fourth aspect, alone or in combination with one or more of the first through third aspects, selecting the second CPE is based at least in part on an autonomous selection and includes one of a random selection, a sidelink transmission priority based selection, or a random selection based at least in part on a sidelink transmission priority.

In a fifth aspect, alone or in combination with one or more of the first through fourth aspects, the CPE is associated with a second set of CPEs based at least in part on the CPE being selected autonomously at the first UE.

In a sixth aspect, alone or in combination with one or more of the first through fifth aspects, process 200 includes selecting a default CPE from a set of CPEs.

In a seventh aspect, alone or in combination with one or more of the first through sixth aspects, the default CPE is selected based at least in part on the sidelink transmission being associated with a partial resource block set allocation.

In an eighth aspect, alone or in combination with one or more of the first through seventh aspects, the default CPE is selected based at least in part on a receipt of a reservation message from a third UE for a resource starting at a same starting slot associated with the sidelink transmission.

In a ninth aspect, alone or in combination with one or more of the first through eighth aspects, the default CPE is selected based at least in part on the first UE transmitting a reservation message associated with the sidelink transmission.

In a tenth aspect, alone or in combination with one or more of the first through ninth aspects, the default CPE is predefined in a specification, configured for the first UE, or indicated to the first UE via sidelink control information.

In an eleventh aspect, alone or in combination with one or more of the first through tenth aspects, the set of CPEs includes one or more prohibited CPEs.

In a twelfth aspect, alone or in combination with one or more of the first through eleventh aspects, the one or more prohibited CPEs are predefined in a specification or configured for the first UE.

In a thirteenth aspect, alone or in combination with one or more of the first through twelfth aspects, the one or more prohibited CPEs are based at least in part on a detection of another UE transmission.

In a fourteenth aspect, alone or in combination with one or more of the first through thirteenth aspects, the first UE is a COT responding UE.

In a fifteenth aspect, alone or in combination with one or more of the first through fourteenth aspects, the second UE is a COT initiating UE.

Although FIG. 20 shows example blocks of process 2000, in some aspects, process 2000 may include additional blocks, fewer blocks, different blocks, or differently arranged blocks than those depicted in FIG. 20. Additionally, or alternatively, two or more of the blocks of process 2000 may be performed in parallel.

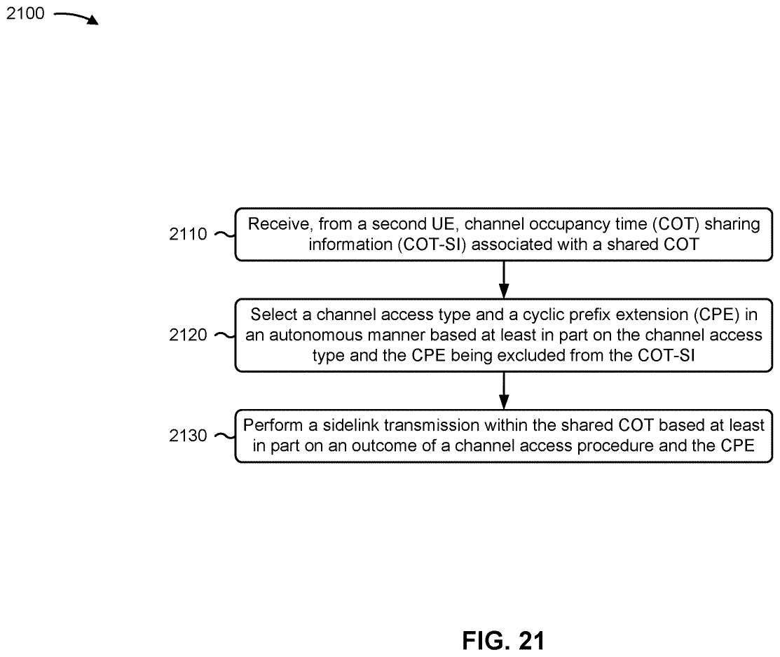

FIG. 21 is a diagram illustrating an example process 2100 performed, for example, by a first UE, in accordance with the present disclosure. Example process 2100 is an example where the first UE (e.g., UE 120a) performs operations associated with a CPE selection for a shared COT.

As shown in FIG. 21, in some aspects, process 2100 may include receiving, from a second UE, COT-SI associated with a shared COT (block 2110). For example, the first UE (e.g., using communication manager 140 and/or reception component 2302, depicted in FIG. 23) may receive, from a second UE, COT-SI associated with a shared COT, as described above.

As further shown in FIG. 21, in some aspects, process 2100 may include selecting a channel access type and a CPE in an autonomous manner based at least in part on the channel access type and the CPE being excluded from the COT-SI (block 2120). For example, the first UE (e.g., using communication manager 140 and/or selection component 2308, depicted in FIG. 23) may select a channel access type and a CPE in an autonomous manner based at least in part on the channel access type and the CPE being excluded from the COT-SI, as described above.

As further shown in FIG. 21, in some aspects, process 2100 may include performing a sidelink transmission within the shared COT based at least in part on an outcome of a channel access procedure and the CPE (block 2130). For example, the first UE (e.g., using communication manager 140 and/or performing component 2304, depicted in FIG. 23) may perform a sidelink transmission within the shared COT based at least in part on an outcome of a channel access procedure and the CPE, as described above.

Process 2100 may include additional aspects, such as any single aspect or any combination of aspects described below and/or in connection with one or more other processes described elsewhere herein.

In a first aspect, the channel access type is a default channel access type, or the channel access type is an upgraded channel access type based at least in part on detecting another sidelink transmission from the second UE or a third UE in a slot prior to the sidelink transmission.

In a second aspect, alone or in combination with the first aspect, detecting another sidelink transmission is based at least in part on a received sidelink control information.

In a third aspect, alone or in combination with one or more of the first and second aspects, selecting the CPE is based at least in part on an autonomous selection and includes one of a random selection, a sidelink transmission priority based selection, or a random selection based at least in part on a sidelink transmission priority.

In a fourth aspect, alone or in combination with one or more of the first through third aspects, the CPE is associated with a second set of CPEs based at least in part on the CPE being selected autonomously at the first UE.

In a fifth aspect, alone or in combination with one or more of the first through fourth aspects, process 2100 includes selecting a default CPE from a set of CPEs.

In a sixth aspect, alone or in combination with one or more of the first through fifth aspects, the default CPE is selected based at least in part on the sidelink transmission being associated with a partial resource block set allocation.

In a seventh aspect, alone or in combination with one or more of the first through sixth aspects, the default CPE is selected based at least in part on a receipt of a reservation message from a third UE for a resource starting at a same starting slot associated with the sidelink transmission.

In an eighth aspect, alone or in combination with one or more of the first through seventh aspects, the default CPE is selected based at least in part on the first UE transmitting a reservation message associated with the sidelink transmission.

In a ninth aspect, alone or in combination with one or more of the first through eighth aspects, the default CPE is predefined in a specification, configured for the first UE, or indicated to the first UE via sidelink control information.

In a tenth aspect, alone or in combination with one or more of the first through ninth aspects, the set of CPEs includes one or more prohibited CPEs.

In an eleventh aspect, alone or in combination with one or more of the first through tenth aspects, the one or more prohibited CPEs are predefined in a specification or configured for the first UE.

In a twelfth aspect, alone or in combination with one or more of the first through eleventh aspects, the one or more prohibited CPEs are based at least in part on a detection of another UE transmission.

In a thirteenth aspect, alone or in combination with one or more of the first through twelfth aspects, the first UE is a COT responding UE.

In a fourteenth aspect, alone or in combination with one or more of the first through thirteenth aspects, the second UE is a COT initiating UE.

Although FIG. 21 shows example blocks of process 2100, in some aspects, process 2100 may include additional blocks, fewer blocks, different blocks, or differently arranged blocks than those depicted in FIG. 21. Additionally, or alternatively, two or more of the blocks of process 2100 may be performed in parallel.

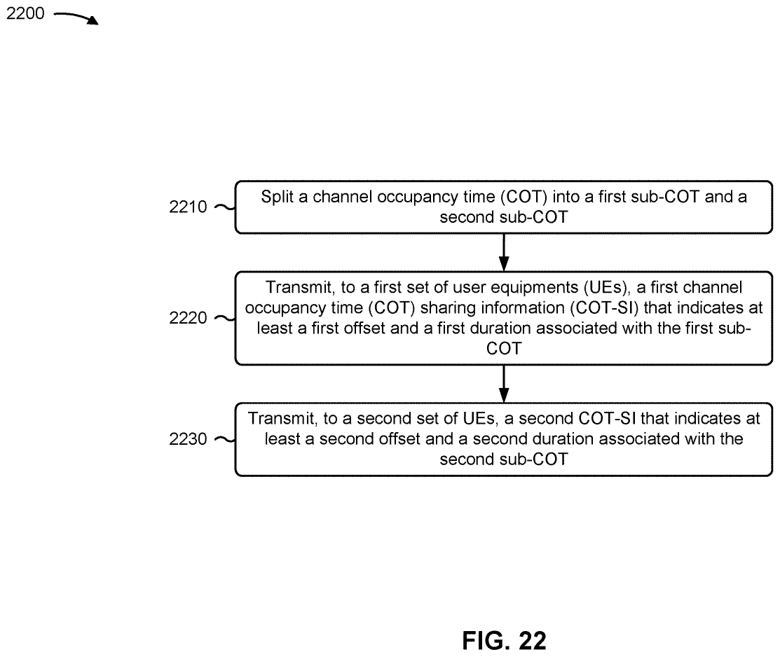

FIG. 22 is a diagram illustrating an example process 2200 performed, for example, by a second UE, in accordance with the present disclosure. Example process 2200 is an example where the second UE (e.g., UE 120e) performs operations associated with a CPE selection for a shared COT.

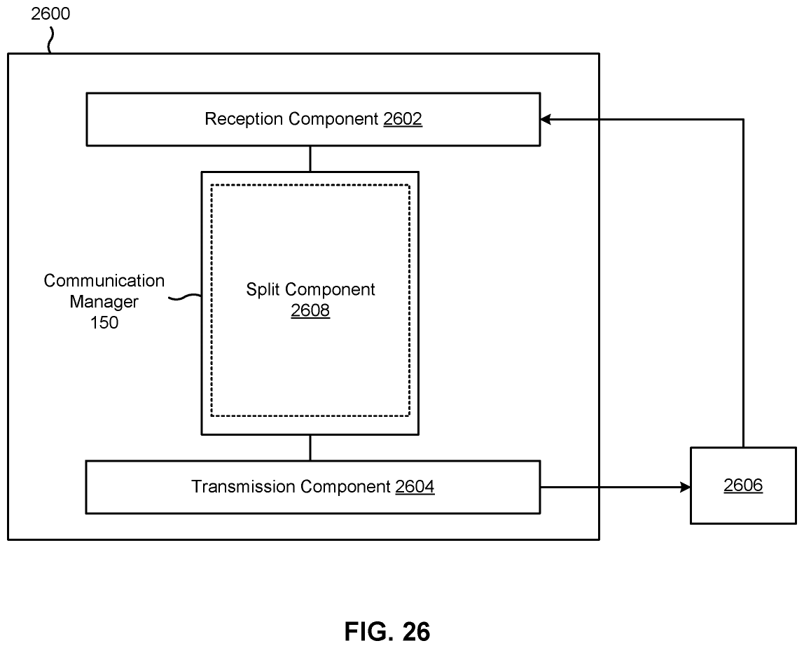

As shown in FIG. 22, in some aspects, process 2200 may include splitting a COT into a first sub-COT and a second sub-COT (block 2210). For example, the second UE (e.g., using communication manager 150 and/or split component 2608, depicted in FIG. 26) may split a COT into a first sub-COT and a second sub-COT, as described above.

As further shown in FIG. 22, in some aspects, process 2200 may include transmitting, to a first set of UEs, a first COT-SI that indicates at least a first offset and a first duration associated with the first sub-COT (block 2220). For example, the second UE (e.g., using communication manager 150 and/or transmission component 2604, depicted in FIG. 26) may transmit, to a first set of UEs, a first COT-SI that indicates at least a first offset and a first duration associated with the first sub-COT, as described above.

As further shown in FIG. 22, in some aspects, process 2200 may include transmitting, to a second set of UEs, a second COT-SI that indicates at least a second offset and a second duration associated with the second sub-COT (block 2230). For example, the second UE (e.g., using communication manager 150 and/or transmission component 2604, depicted in FIG. 26) may transmit, to a second set of UEs, a second COT-SI that indicates at least a second offset and a second duration associated with the second sub-COT, as described above.

Process 2200 may include additional aspects, such as any single aspect or any combination of aspects described below and/or in connection with one or more other processes described elsewhere herein.

In a first aspect, the first COT-SI indicates one or more of a first channel access type or a first CPE.

In a second aspect, alone or in combination with the first aspect, the second COT-SI indicates one or more of a second channel access type or a second CPE.

In a third aspect, alone or in combination with one or more of the first and second aspects, the COT is formed based at least in part on a concatenation of different regions.

In a fourth aspect, alone or in combination with one or more of the first through third aspects, the first set of UEs includes one or more UEs.

In a fifth aspect, alone or in combination with one or more of the first through fourth aspects, the second set of UEs includes one or more UEs.

In a sixth aspect, alone or in combination with one or more of the first through fifth aspects, the first set of UEs and the second set of UEs include COT responding UEs.

In a seventh aspect, alone or in combination with one or more of the first through sixth aspects, the second UE is a COT initiating UE.

Although FIG. 22 shows example blocks of process 2200, in some aspects, process 2200 may include additional blocks, fewer blocks, different blocks, or differently arranged blocks than those depicted in FIG. 22. Additionally, or alternatively, two or more of the blocks of process 2200 may be performed in parallel.

FIG. 23 is a diagram of an example apparatus 2300 for wireless communication, in accordance with the present disclosure. The apparatus 2300 may be a first UE, or a first UE may include the apparatus 2300. In some aspects, the apparatus 2300 includes a reception component 2302 and a transmission component 2304, which may be in communication with one another (for example, via one or more buses and/or one or more other components). As shown, the apparatus 2300 may communicate with another apparatus 2306 (such as a UE, a base station, or another wireless communication device) using the reception component 2302 and the transmission component 2304. As further shown, the apparatus 2300 may include the communication manager 140. The communication manager 140 may include a selection component 2308, among other examples.

In some aspects, the apparatus 2300 may be configured to perform one or more operations described herein in connection with FIGS. 4-18. Additionally, or alternatively, the apparatus 2300 may be configured to perform one or more processes described herein, such as process 1900 of FIG. 19, process 2000 of FIG. 20, and/or process 2100 of FIG. 21. In some aspects, the apparatus 2300 and/or one or more components shown in FIG. 23 may include one or more components of the first UE described in connection with FIG. 2. Additionally, or alternatively, one or more components shown in FIG. 23 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 2302 may receive communications, such as reference signals, control information, data communications, or a combination thereof, from the apparatus 2306. The reception component 2302 may provide received communications to one or more other components of the apparatus 2300. In some aspects, the reception component 2302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2300. In some aspects, the reception component 2302 may include one or more antennas, a modem, a demodulator, a MIMO detector, a receive processor, a controller/processor, a memory, or a combination thereof, of the first UE described in connection with FIG. 2.

The transmission component 2304 may transmit communications, such as reference signals, control information, data communications, or a combination thereof, to the apparatus 2306. In some aspects, one or more other components of the apparatus 2300 may generate communications and may provide the generated communications to the transmission component 2304 for transmission to the apparatus 2306. In some aspects, the transmission component 2304 may perform signal processing on the generated communications (such as filtering, amplification, modulation, digital-to-analog conversion, multiplexing, interleaving, mapping, or encoding, among other examples), and may transmit the processed signals to the apparatus 2306. In some aspects, the transmission component 2304 may include one or more antennas, a modem, a modulator, a transmit MIMO processor, a transmit processor, a controller/processor, a memory, or a combination thereof, of the first UE described in connection with FIG. 2. In some aspects, the transmission component 2304 may be co-located with the reception component 2302 in a transceiver.

The reception component 2302 may receive, from a second UE, COT-SI indicating at least an offset, a channel access type, and a CPE associated with a shared COT. The selection component 2308 may select the channel access type and the CPE, as indicated by the COT-SI, based at least in part on a sidelink transmission to be transmitted at the offset. The transmission component 2304 may perform the sidelink transmission within the shared COT based at least in part on an outcome of a channel access procedure and the CPE.

The reception component 2302 may receive, from a second UE, COT-SI indicating at least an offset, a first channel access type, and a first CPE associated with a shared COT. The selection component 2308 may select, in an autonomous manner, a second channel access type and a second CPE, different or same from the first channel access type and the second CPE indicated by the COT-SI, based at least in part on a sidelink transmission to be transmitted after the offset. The transmission component 2304 may perform the sidelink transmission within the shared COT based at least in part on an outcome of a channel access procedure and the second CPE.

The reception component 2302 may receive, from a second UE, COT-SI associated with a shared COT. The selection component 2308 may select a channel access type and a CPE in an autonomous manner based at least in part on the channel access type and the CPE being excluded from the COT-SI. The transmission component 2304 may perform a sidelink transmission within the shared COT based at least in part on an outcome of a channel access procedure and the CPE.

The reception component 2302 may receive, from a second UE, COT-SI associated with a shared COT. The selection component 2308 may select a channel access type and a CPE in an autonomous manner based at least in part on the COT-SI, wherein the channel access type is one or more of a default channel access type or an upgraded channel access type, and the upgraded channel access type is based at least in part on a detection of another sidelink transmission in a slot prior to a sidelink transmission. The transmission component 2304 may perform the sidelink transmission within the shared COT based at least in part on an outcome of a channel access procedure and the CPE.

The number and arrangement of components shown in FIG. 23 are provided as an example. In practice, there may be additional components, fewer components, different components, or differently arranged components than those shown in FIG. 23. Furthermore, two or more components shown in FIG. 23 may be implemented within a single component, or a single component shown in FIG. 23 may be implemented as multiple, distributed components. Additionally, or alternatively, a set of (one or more) components shown in FIG. 23 may perform one or more functions described as being performed by another set of components shown in FIG. 23.

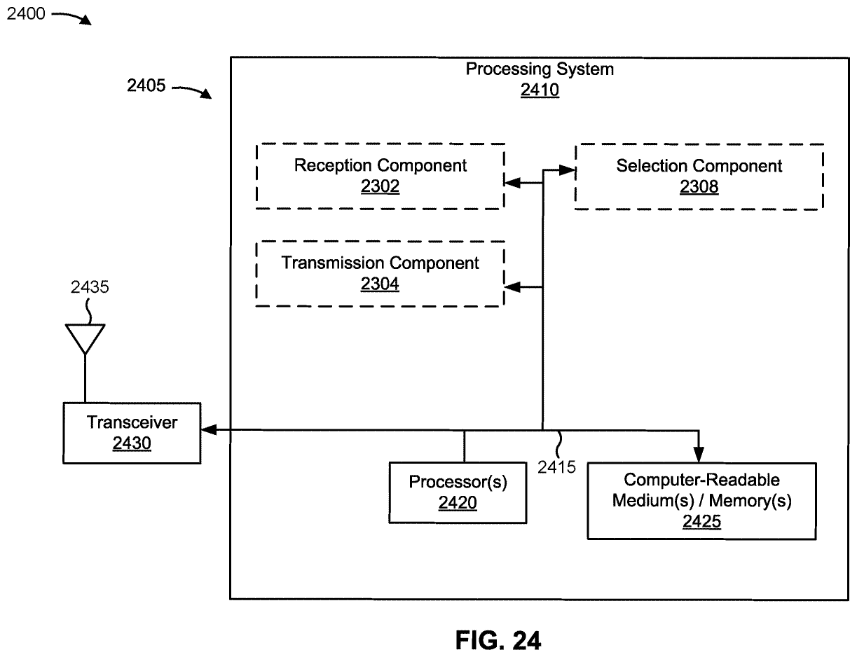

FIG. 24 is a diagram illustrating an example 2400 of a hardware implementation for an apparatus 2405 employing a processing system 2410, in accordance with the present disclosure. The apparatus 2405 may be a first UE.

The processing system 2410 may be implemented with a bus architecture, represented generally by the bus 2415. The bus 2415 may include any number of interconnecting buses and bridges depending on the specific application of the processing system 2410 and the overall design constraints. The bus 2415 links together various circuits including one or more processors and/or hardware components, represented by the processor 2420, the illustrated components, and the computer-readable medium/memory 2425. The bus 2415 may also link various other circuits, such as timing sources, peripherals, voltage regulators, and/or power management circuits.

The processing system 2410 may be coupled to a transceiver 2430. The transceiver 2430 is coupled to one or more antennas 2435. The transceiver 2430 provides a means for communicating with various other apparatuses over a transmission medium. The transceiver 2430 receives a signal from the one or more antennas 2435, extracts information from the received signal, and provides the extracted information to the processing system 2410, specifically the reception component 2302. In addition, the transceiver 2430 receives information from the processing system 2410, specifically the transmission component 2304, and generates a signal to be applied to the one or more antennas 2435 based at least in part on the received information.

The processing system 2410 includes a processor 2420 coupled to a computer-readable medium/memory 2425. The processor 2420 is responsible for general processing, including the execution of software stored on the computer-readable medium/memory 2425.

The software, when executed by the processor 2420, causes the processing system 2410 to perform the various functions described herein for any particular apparatus. The computer-readable medium/memory 2425 may also be used for storing data that is manipulated by the processor 2420 when executing software. The processing system further includes at least one of the illustrated components. The components may be software modules running in the processor 2420, resident/stored in the computer readable medium/memory 2425, one or more hardware modules coupled to the processor 2420, or some combination thereof.

In some aspects, the processing system 2410 may be a component of the UE 120 and may include the memory 282 and/or at least one of the TX MIMO processor 266, the RX processor 258, and/or the controller/processor 280.

In some aspects, the apparatus 2405 for wireless communication includes means for receiving COT-SI indicating at least an offset, a channel access type, and a CPE associated with a shared COT; means for selecting the channel access type and the CPE, as indicated by the COT-SI, based at least in part on a sidelink transmission to be transmitted at the offset; and/or means for performing the sidelink transmission within the shared COT based at least in part on an outcome of a channel access procedure and the CPE.

In some aspects, the apparatus 2405 for wireless communication includes means for receiving COT-SI indicating at least an offset, a first channel access type, and a first CPE associated with a shared COT; means for selecting, in an autonomous manner, a second channel access type and a second CPE, different or same from the first channel access type and the second CPE indicated by the COT-SI, based at least in part on a sidelink transmission to be transmitted after the offset; and/or means for performing the sidelink transmission within the shared COT based at least in part on an outcome of a channel access procedure and the second CPE.

In some aspects, the apparatus 2405 for wireless communication includes means for receiving COT-SI associated with a shared COT; means for selecting a channel access type and a CPE in an autonomous manner based at least in part on the channel access type and the CPE being excluded from the COT-SI; and/or means for performing a sidelink transmission within the shared COT based at least in part on an outcome of a channel access procedure and the CPE.

In some aspects, the apparatus 2405 for wireless communication includes means for receiving COT-SI associated with a shared COT; means for selecting a channel access type and a CPE in an autonomous manner based at least in part on the COT-SI, wherein the channel access type is one or more of a default channel access type or an upgraded channel access type, and the upgraded channel access type is based at least in part on a detection of another sidelink transmission in a slot prior to a sidelink transmission; and/or means for performing the sidelink transmission within the shared COT based at least in part on an outcome of a channel access procedure and the CPE.

The aforementioned means may be one or more of the aforementioned components of the apparatus 2300 and/or the processing system 2410 of the apparatus 2405 configured to perform the functions recited by the aforementioned means. As described elsewhere herein, the processing system 2410 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 24 is provided as an example. Other examples may differ from what is described in connection with FIG. 24.

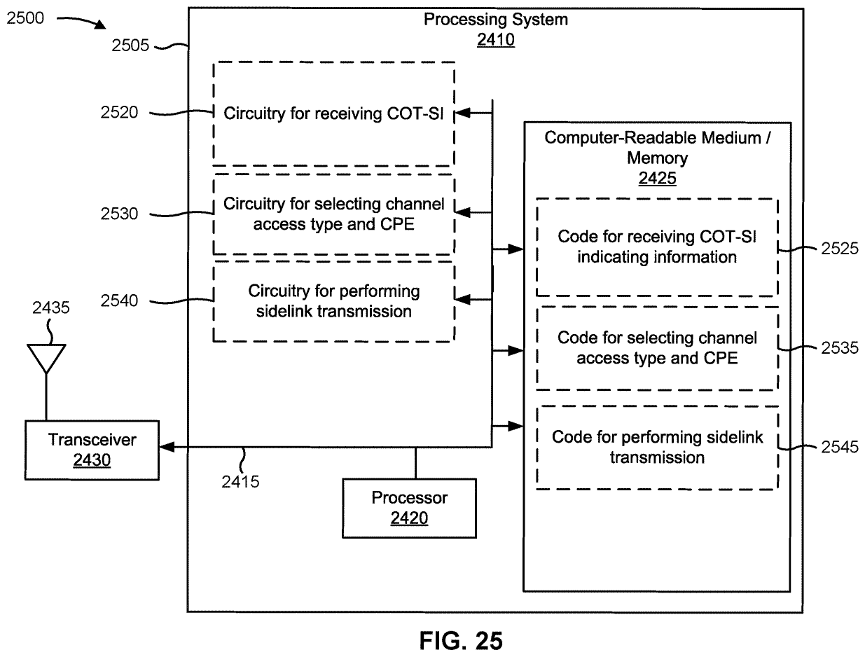

FIG. 25 is a diagram illustrating an example 2500 of an implementation of code and circuitry for an apparatus 2505, in accordance with the present disclosure. The apparatus 2505 may be a first UE, or a first UE may include the apparatus 2505.

As shown in FIG. 25, the apparatus 2505 may include circuitry for receiving COT-SI indicating at least an offset, a channel access type, and a CPE associated with a shared COT (circuitry 2520). For example, the circuitry 2520 may enable the apparatus 2505 to receive COT-SI indicating at least an offset, a channel access type, and a CPE associated with a shared COT. As shown in FIG. 25, the apparatus 2505 may include circuitry for receiving COT-SI indicating at least an offset, a first channel access type, and a first CPE associated with a shared COT (circuitry 2520). For example, the circuitry 2520 may enable the apparatus 2505 to receive COT-SI indicating at least an offset, a first channel access type, and a first CPE associated with a shared COT. As shown in FIG. 25, the apparatus 2505 may include circuitry for receiving COT-SI associated with a shared COT (circuitry 2520). For example, the circuitry 2520 may enable the apparatus 2505 to receive COT-SI associated with a shared COT.

As shown in FIG. 25, the apparatus 2505 may include, stored in computer-readable medium 2425, code for receiving COT-SI indicating at least an offset, a channel access type, and a CPE associated with a shared COT (code 2525). For example, the code 2525, when executed by processor 2420, may cause processor 2420 to cause transceiver 2450 to receive COT-SI indicating at least an offset, a channel access type, and a CPE associated with a shared COT. As shown in FIG. 25, the apparatus 2505 may include, stored in computer-readable medium 2425, code for receiving COT-SI indicating at least an offset, a first channel access type, and a first CPE associated with a shared COT (code 2525). For example, the code 2525, when executed by processor 2420, may cause processor 2420 to cause transceiver 2450 to receive COT-SI indicating at least an offset, a first channel access type, and a first CPE associated with a shared COT. As shown in FIG. 25, the apparatus 2505 may include, stored in computer-readable medium 2425, code for receiving COT-SI associated with a shared COT (code 2525). For example, the code 2525, when executed by processor 2420, may cause processor 2420 to cause transceiver 2450 to receive COT-SI associated with a shared COT.

As shown in FIG. 25, the apparatus 2505 may include circuitry for selecting the channel access type and the CPE, as indicated by the COT-SI, based at least in part on a sidelink transmission to be transmitted at the offset (circuitry 2530). For example, the circuitry 2530 may enable the apparatus 2505 to select the channel access type and the CPE, as indicated by the COT-SI, based at least in part on a sidelink transmission to be transmitted at the offset. As shown in FIG. 25, the apparatus 2505 may include circuitry for selecting, in an autonomous manner, a second channel access type and a second CPE, different or same from the first channel access type and the second CPE indicated by the COT-SI, based at least in part on a sidelink transmission to be transmitted after the offset (circuitry 2530). For example, the circuitry 2530 may enable the apparatus 2505 to select, in an autonomous manner, a second channel access type and a second CPE, different or same from the first channel access type and the second CPE indicated by the COT-SI, based at least in part on a sidelink transmission to be transmitted after the offset. As shown in FIG. 25, the apparatus 2505 may include circuitry for selecting a channel access type and a CPE in an autonomous manner based at least in part on the channel access type and the CPE being excluded from the COT-SI (circuitry 2530). For example, the circuitry 2530 may enable the apparatus 2505 to select a channel access type and a CPE in an autonomous manner based at least in part on the channel access type and the CPE being excluded from the COT-SI. As shown in FIG. 25, the apparatus 2505 may include circuitry for selecting a channel access type and a CPE in an autonomous manner based at least in part on the COT-SI, wherein the channel access type is one or more of a default channel access type or an upgraded channel access type, and the upgraded channel access type is based at least in part on a detection of another sidelink transmission in a slot prior to a sidelink transmission (circuitry 2530). For example, the circuitry 2530 may enable the apparatus 2505 to select a channel access type and a CPE in an autonomous manner based at least in part on the COT-SI, wherein the channel access type is one or more of a default channel access type or an upgraded channel access type, and the upgraded channel access type is based at least in part on a detection of another sidelink transmission in a slot prior to a sidelink transmission.

As shown in FIG. 25, the apparatus 2505 may include, stored in computer-readable medium 2425, code for selecting the channel access type and the CPE, as indicated by the COT-SI, based at least in part on a sidelink transmission to be transmitted at the offset (code 2535). For example, the code 2535, when executed by processor 2420, may cause processor 2420 to select the channel access type and the CPE, as indicated by the COT-SI, based at least in part on a sidelink transmission to be transmitted at the offset. As shown in FIG. 25, the apparatus 2505 may include, stored in computer-readable medium 2425, code for selecting, in an autonomous manner, a second channel access type and a second CPE, different or same from the first channel access type and the second CPE indicated by the COT-SI, based at least in part on a sidelink transmission to be transmitted after the offset (code 2535). For example, the code 2535, when executed by processor 2420, may cause processor 2420 to select, in an autonomous manner, a second channel access type and a second CPE, different or same from the first channel access type and the second CPE indicated by the COT-SI, based at least in part on a sidelink transmission to be transmitted after the offset. As shown in FIG. 25, the apparatus 2505 may include, stored in computer-readable medium 2425, code for selecting a channel access type and a CPE in an autonomous manner based at least in part on the channel access type and the CPE being excluded from the COT-SI (code 2535). For example, the code 2535, when executed by processor 2420, may cause processor 2420 to select a channel access type and a CPE in an autonomous manner based at least in part on the channel access type and the CPE being excluded from the COT-SI. As shown in FIG. 25, the apparatus 2505 may include, stored in computer-readable medium 2425, code for selecting a channel access type and a CPE in an autonomous manner based at least in part on the COT-SI, wherein the channel access type is one or more of a default channel access type or an upgraded channel access type, and the upgraded channel access type is based at least in part on a detection of another sidelink transmission in a slot prior to a sidelink transmission (code 2535). For example, the code 2535, when executed by processor 2420, may cause processor 2420 to select a channel access type and a cyclic prefix extension (CPE) in an autonomous manner based at least in part on the COT-SI, wherein the channel access type is one or more of a default channel access type or an upgraded channel access type, and the upgraded channel access type is based at least in part on a detection of another sidelink transmission in a slot prior to a sidelink transmission.

As shown in FIG. 25, the apparatus 2505 may include circuitry for performing the sidelink transmission within the shared COT based at least in part on an outcome of a channel access procedure and the CPE (circuitry 2540). For example, the circuitry 2540 may enable the apparatus 2505 to perform the sidelink transmission within the shared COT based at least in part on an outcome of a channel access procedure and the CPE. As shown in FIG. 25, the apparatus 2505 may include circuitry for performing the sidelink transmission within the shared COT based at least in part on an outcome of a channel access procedure and the second CPE (circuitry 2540). For example, the circuitry 2540 may enable the apparatus 2505 to perform the sidelink transmission within the shared COT based at least in part on an outcome of a channel access procedure and the second CPE. As shown in FIG. 25, the apparatus 2505 may include circuitry for performing a sidelink transmission within the shared COT based at least in part on an outcome of a channel access procedure and the CPE (circuitry 2540). For example, the circuitry 2540 may enable the apparatus 2505 to perform a sidelink transmission within the shared COT based at least in part on an outcome of a channel access procedure and the CPE.

As shown in FIG. 25, the apparatus 2505 may include, stored in computer-readable medium 2425, code for performing the sidelink transmission within the shared COT based at least in part on an outcome of a channel access procedure and the CPE (code 2545). For example, the code 2545, when executed by processor 2420, may cause processor 2420 to cause transceiver 2450 to perform the sidelink transmission within the shared COT based at least in part on an outcome of a channel access procedure and the CPE. As shown in FIG. 25, the apparatus 2505 may include, stored in computer-readable medium 2425, code for performing the sidelink transmission within the shared COT based at least in part on an outcome of a channel access procedure and the second CPE (code 2545). For example, the code 2545, when executed by processor 2420, may cause processor 2420 to cause transceiver 2450 to perform the sidelink transmission within the shared COT based at least in part on an outcome of a channel access procedure and the second CPE. As shown in FIG. 25, the apparatus 2505 may include, stored in computer-readable medium 2425, code for performing a sidelink transmission within the shared COT based at least in part on an outcome of a channel access procedure and the CPE (code 2545). For example, the code 2545, when executed by processor 2420, may cause processor 2420 to cause transceiver 2450 to perform a sidelink transmission within the shared COT based at least in part on an outcome of a channel access procedure and the CPE.

FIG. 25 is provided as an example. Other examples may differ from what is described in connection with FIG. 25.

FIG. 26 is a diagram of an example apparatus 2600 for wireless communication, in accordance with the present disclosure. The apparatus 2600 may be a second UE, or a second UE may include the apparatus 2600. In some aspects, the apparatus 2600 includes a reception component 2602 and a transmission component 2604, which may be in communication with one another (for example, via one or more buses and/or one or more other components). As shown, the apparatus 2600 may communicate with another apparatus 2606 (such as a UE, a base station, or another wireless communication device) using the reception component 2602 and the transmission component 2604. The communication manager 150 may include a split component 2608, among other examples.

In some aspects, the apparatus 2600 may be configured to perform one or more operations described herein in connection with FIGS. 4-18. Additionally, or alternatively, the apparatus 2600 may be configured to perform one or more processes described herein, such as process 2200 of FIG. 22. In some aspects, the apparatus 2600 and/or one or more components shown in FIG. 26 may include one or more components of the second UE described in connection with FIG. 2. Additionally, or alternatively, one or more components shown in FIG. 26 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 2602 may receive communications, such as reference signals, control information, data communications, or a combination thereof, from the apparatus 2606. The reception component 2602 may provide received communications to one or more other components of the apparatus 2600. In some aspects, the reception component 2602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2600. In some aspects, the reception component 2602 may include one or more antennas, a modem, a demodulator, a MIMO detector, a receive processor, a controller/processor, a memory, or a combination thereof, of the second UE described in connection with FIG. 2.

The transmission component 2604 may transmit communications, such as reference signals, control information, data communications, or a combination thereof, to the apparatus 2606. In some aspects, one or more other components of the apparatus 2600 may generate communications and may provide the generated communications to the transmission component 2604 for transmission to the apparatus 2606. In some aspects, the transmission component 2604 may perform signal processing on the generated communications (such as filtering, amplification, modulation, digital-to-analog conversion, multiplexing, interleaving, mapping, or encoding, among other examples), and may transmit the processed signals to the apparatus 2606. In some aspects, the transmission component 2604 may include one or more antennas, a modem, a modulator, a transmit MIMO processor, a transmit processor, a controller/processor, a memory, or a combination thereof, of the second UE described in connection with FIG. 2. In some aspects, the transmission component 2604 may be co-located with the reception component 2602 in a transceiver.

The split component 2608 may split a COT into a first sub-COT and a second sub-COT. The transmission component 2604 may transmit, to a first set of UEs, a first COT-SI that indicates at least a first offset and a first duration associated with the first sub-COT. The transmission component 2604 may transmit, to a second set of UEs, a second COT-SI that indicates at least a second offset and a second duration associated with the second sub-COT.

The number and arrangement of components shown in FIG. 26 are provided as an example. In practice, there may be additional components, fewer components, different components, or differently arranged components than those shown in FIG. 26. Furthermore, two or more components shown in FIG. 26 may be implemented within a single component, or a single component shown in FIG. 26 may be implemented as multiple, distributed components. Additionally, or alternatively, a set of (one or more) components shown in FIG. 26 may perform one or more functions described as being performed by another set of components shown in FIG. 26.

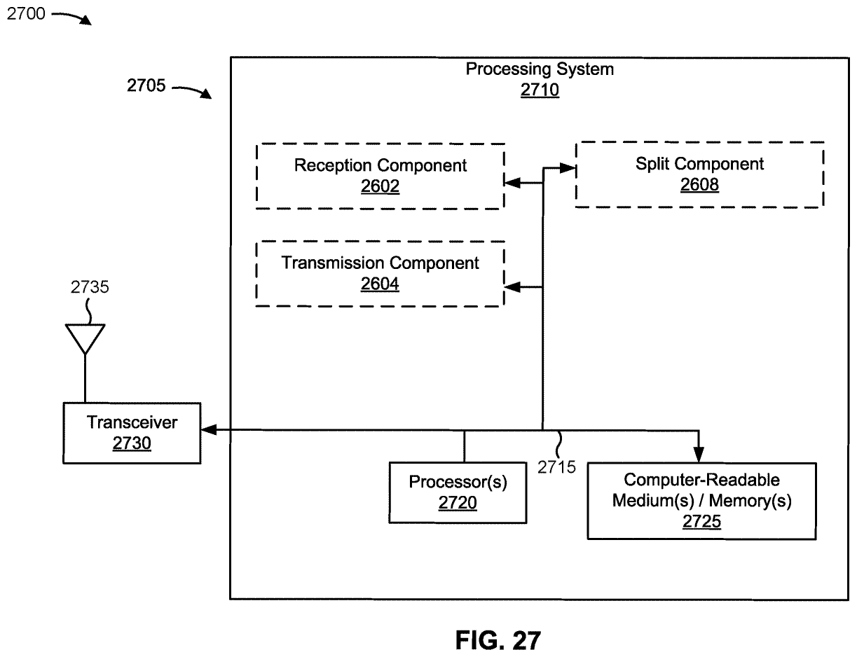

FIG. 27 is a diagram illustrating an example 2700 of a hardware implementation for an apparatus 2705 employing a processing system 2710, in accordance with the present disclosure. The apparatus 2705 may be a second UE.

The processing system 2710 may be implemented with a bus architecture, represented generally by the bus 2715. The bus 2715 may include any number of interconnecting buses and bridges depending on the specific application of the processing system 2710 and the overall design constraints. The bus 2715 links together various circuits including one or more processors and/or hardware components, represented by the processor 2720, the illustrated components, and the computer-readable medium/memory 2727. The bus 2715 may also link various other circuits, such as timing sources, peripherals, voltage regulators, and/or power management circuits.

The processing system 2710 may be coupled to a transceiver 2730. The transceiver 2730 is coupled to one or more antennas 2735. The transceiver 2730 provides a means for communicating with various other apparatuses over a transmission medium. The transceiver 2730 receives a signal from the one or more antennas 2735, extracts information from the received signal, and provides the extracted information to the processing system 2710, specifically the reception component 2602. In addition, the transceiver 2730 receives information from the processing system 2710, specifically the transmission component 2604, and generates a signal to be applied to the one or more antennas 2735 based at least in part on the received information.

The processing system 2710 includes a processor 2720 coupled to a computer-readable medium/memory 2727. The processor 2720 is responsible for general processing, including the execution of software stored on the computer-readable medium/memory 2727. The software, when executed by the processor 2720, causes the processing system 2710 to perform the various functions described herein for any particular apparatus. The computer-readable medium/memory 2727 may also be used for storing data that is manipulated by the processor 2720 when executing software. The processing system further includes at least one of the illustrated components. The components may be software modules running in the processor 2720, resident/stored in the computer readable medium/memory 2727, one or more hardware modules coupled to the processor 2720, or some combination thereof.

In some aspects, the processing system 2710 may be a component of the UE 120 and may include the memory 282 and/or at least one of the TX MIMO processor 266, the RX processor 278, and/or the controller/processor 280. In some aspects, the apparatus 2705 for wireless communication includes means for transmitting COT-SI indicating information associated with a shared COT, a channel access type and a CPE being based at least in part on the COT-SI. The aforementioned means may be one or more of the aforementioned components of the apparatus 2600 and/or the processing system 2710 of the apparatus 2705 configured to perform the functions recited by the aforementioned means. As described elsewhere herein, the processing system 2710 may include the TX MIMO processor 266, the RX processor 278, and/or the controller/processor 280. In one configuration, the aforementioned means may be the TX MIMO processor 266, the RX processor 278, and/or the controller/processor 280 configured to perform the functions and/or operations recited herein.

FIG. 27 is provided as an example. Other examples may differ from what is described in connection with FIG. 27.

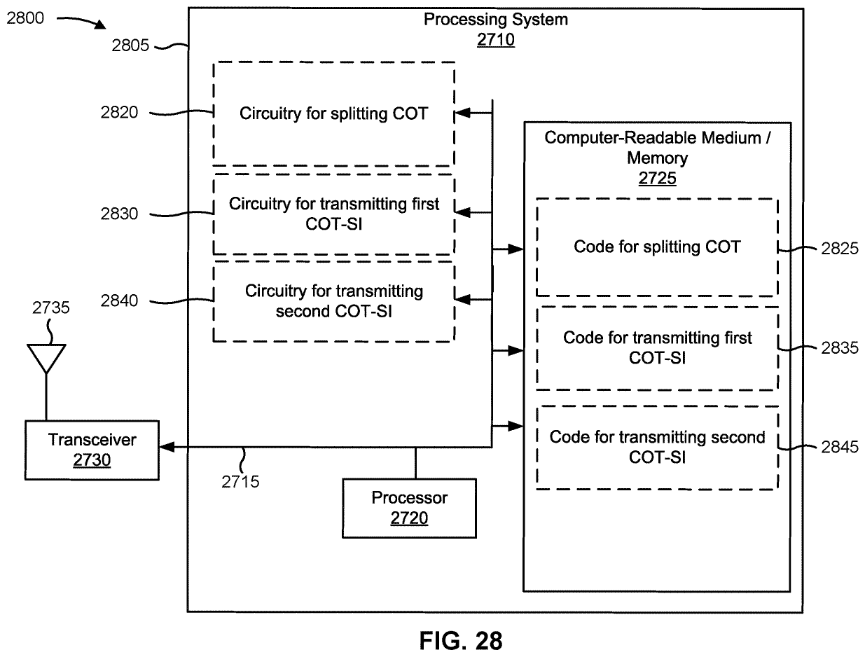

FIG. 28 is a diagram illustrating an example 2800 of an implementation of code and circuitry for an apparatus 2805, in accordance with the present disclosure. The apparatus 2805 may be a second UE, or a second UE may include the apparatus 2805.

As shown in FIG. 28, the apparatus 2805 may include circuitry for splitting a channel occupancy time (COT) into a first sub-COT and a second sub-COT (circuitry 2820). For example, the circuitry 2820 may enable the apparatus 2805 to split a channel occupancy time (COT) into a first sub-COT and a second sub-COT.

As shown in FIG. 28, the apparatus 2805 may include, stored in computer-readable medium 2725, code for splitting a channel occupancy time (COT) into a first sub-COT and a second sub-COT (code 2825). For example, the code 2825, when executed by processor 2720, may cause processor 2720 to split a channel occupancy time (COT) into a first sub-COT and a second sub-COT.

As shown in FIG. 28, the apparatus 2805 may include circuitry for transmitting, to a first set of UEs, a first COT-SI that indicates at least a first offset and a first duration associated with the first sub-COT (circuitry 2820). For example, the circuitry 2820 may enable the apparatus 2805 to transmit, to a first set of UEs, a first COT-SI that indicates at least a first offset and a first duration associated with the first sub-COT.

As shown in FIG. 28, the apparatus 2805 may include, stored in computer-readable medium 2725, code for transmitting, to a first set of UEs, a first COT-SI that indicates at least a first offset and a first duration associated with the first sub-COT (code 2825). For example, the code 2825, when executed by processor 2720, may cause processor 2720 to cause transceiver 2730 to transmit, to a first set of UEs, a first COT-SI that indicates at least a first offset and a first duration associated with the first sub-COT.

As shown in FIG. 28, the apparatus 2805 may include circuitry for transmitting, to a second set of UEs, a second COT-SI that indicates at least a second offset and a second duration associated with the second sub-COT (circuitry 2820). For example, the circuitry 2820 may enable the apparatus 2805 to transmit, to a second set of UEs, a second COT-SI that indicates at least a second offset and a second duration associated with the second sub-COT.

As shown in FIG. 28, the apparatus 2805 may include, stored in computer-readable medium 2725, code for transmitting, to a second set of UEs, a second COT-SI that indicates at least a second offset and a second duration associated with the second sub-COT (code 2825). For example, the code 2825, when executed by processor 2720, may cause processor 2720 to cause transceiver 2730 to transmit, to a second set of UEs, a second COT-SI that indicates at least a second offset and a second duration associated with the second sub-COT.

FIG. 28 is provided as an example. Other examples may differ from what is described in connection with FIG. 28.

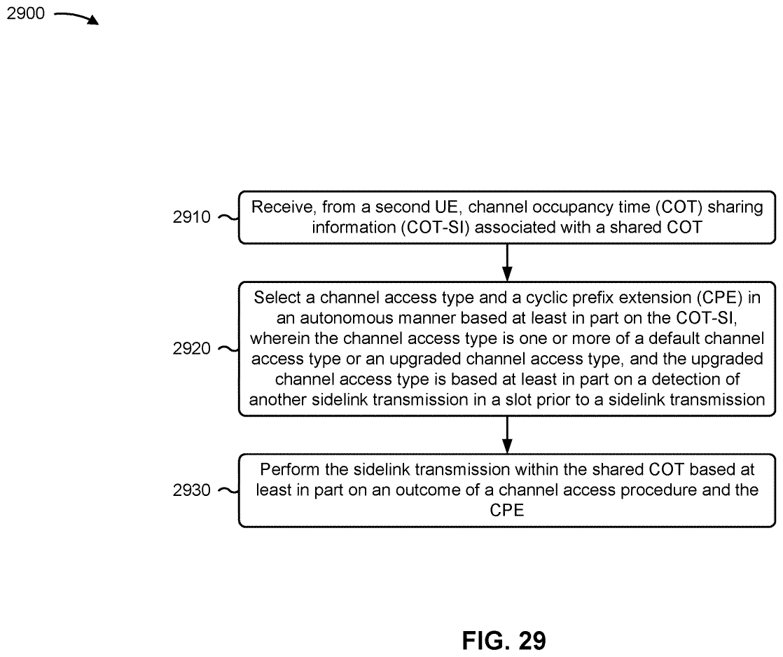

FIG. 29 is a diagram illustrating an example process 2900 performed, for example, by a first UE, in accordance with the present disclosure. Example process 2900 is an example where the first UE (e.g., UE 120a) performs operations associated with a CPE selection for a shared COT.

As shown in FIG. 29, in some aspects, process 2900 may include receiving, from a second UE, COT-SI associated with a shared COT (block 2910). For example, the first UE (e.g., using communication manager 140 and/or reception component 2302, depicted in FIG. 23) may receive, from a second UE, COT-SI associated with a shared COT, as described above.

As further shown in FIG. 29, in some aspects, process 2900 may include selecting a channel access type and a CPE in an autonomous manner based at least in part on the COT-SI, wherein the channel access type is one or more of a default channel access type or an upgraded channel access type, and the upgraded channel access type is based at least in part on a detection of another sidelink transmission in a slot prior to a sidelink transmission (block 2920). For example, the first UE (e.g., using communication manager 140 and/or selection component 2308, depicted in FIG. 23) may select a channel access type and a CPE in an autonomous manner based at least in part on the COT-SI, wherein the channel access type is one or more of a default channel access type or an upgraded channel access type, and the upgraded channel access type is based at least in part on a detection of another sidelink transmission in a slot prior to a sidelink transmission, as described above.

As further shown in FIG. 29, in some aspects, process 2900 may include performing the sidelink transmission within the shared COT based at least in part on an outcome of a channel access procedure and the CPE (block 2930). For example, the first UE (e.g., using communication manager 140 and/or performing component 2304, depicted in FIG. 23) may perform the sidelink transmission within the shared COT based at least in part on an outcome of a channel access procedure and the CPE, as described above.

Although FIG. 29 shows example blocks of process 2900, in some aspects, process 2900 may include additional blocks, fewer blocks, different blocks, or differently arranged blocks than those depicted in FIG. 29. Additionally, or alternatively, two or more of the blocks of process 2900 may be performed in parallel.

The following provides an overview of some Aspects of the present disclosure:

Aspect 1: A method of wireless communication performed at a first user equipment (UE), comprising: receiving, from a second UE, channel occupancy time (COT) sharing information (COT-SI) indicating at least an offset, a channel access type, and a cyclic prefix extension (CPE) associated with a shared COT; and selecting the channel access type and the CPE, as indicated by the COT-SI, based at least in part on a sidelink transmission to be transmitted at the offset; and performing the sidelink transmission within the shared COT based at least in part on an outcome of a channel access procedure and the CPE.

Aspect 2: The method of Aspect 1, wherein selecting the CPE is based at least in part on the sidelink transmission occurring at a start of a slot indicated by the offset in the COT-SI.

Aspect 3: The method of any of Aspects 1-2, wherein the CPE is associated with a first set of CPEs based at least in part on the CPE being indicated by the COT-SI.

Aspect 4: The method of any of Aspects 1-3, wherein the first UE is a COT responding UE.

Aspect 5: The method of any of Aspects 1-4, wherein the second UE is a COT initiating UE.

Aspect 6: A method of wireless communication performed at a first user equipment (UE), comprising: receiving, from a second UE, channel occupancy time (COT) sharing information (COT-SI) indicating at least an offset, a first channel access type, and a first cyclic prefix extension (CPE) associated with a shared COT; and selecting, in an autonomous manner, a second channel access type and a second CPE, different or same from the first channel access type and the second CPE indicated by the COT-SI, based at least in part on a sidelink transmission to be transmitted after the offset; and performing the sidelink transmission within the shared COT based at least in part on an outcome of a channel access procedure and the second CPE.

Aspect 7: The method of Aspect 6, wherein selecting the second CPE is based at least in part on the sidelink transmission occurring after a start of a slot indicated by the offset in the COT-SI.

Aspect 8: The method of any of Aspects 6-7, wherein the second channel access type is a default channel access type, or the second channel access type is an upgraded channel access type

Aspect 9: The method of Aspect 8, wherein the second channel access type is upgraded based at least in part on detecting another sidelink transmission from the second UE or a third UE in a slot prior to the sidelink transmission.

Aspect 10: The method of Aspect 9, wherein detecting another sidelink transmission is based at least in part on a received sidelink control information.

Aspect 11: The method of any of Aspects 6-10, wherein selecting the second CPE is based at least in part on an autonomous selection and includes one of: a random selection, a sidelink transmission priority based selection, or a random selection based at least in part on a sidelink transmission priority.

Aspect 12: The method of any of Aspects 6-11, wherein the CPE is associated with a second set of CPEs based at least in part on the CPE being selected autonomously at the first UE.

Aspect 13: The method of any of Aspects 6-12, wherein selecting the second CPE comprises selecting a default CPE from a set of CPEs.

Aspect 14: The method of Aspect 13, wherein the default CPE is selected based at least in part on the sidelink transmission being associated with a partial resource block set allocation.

Aspect 15: The method of Aspect 13, wherein the default CPE is selected based at least in part on a receipt of a reservation message from a third UE for a resource starting at a same starting slot associated with the sidelink transmission.

Aspect 16: The method of Aspect 13, wherein the default CPE is selected based at least in part on the first UE transmitting a reservation message associated with the sidelink transmission.

Aspect 17: The method of Aspect 13, wherein the default CPE is predefined in a specification, configured for the first UE, or indicated to the first UE via sidelink control information.

Aspect 18: The method of Aspect 13, wherein the set of CPEs includes one or more prohibited CPEs.

Aspect 19: The method of Aspect 18, wherein the one or more prohibited CPEs are predefined in a specification or configured for the first UE.

Aspect 20: The method of Aspect 18, wherein the one or more prohibited CPEs are based at least in part on a detection of another UE transmission.

Aspect 21: The method of Aspect 20, wherein the detection of another UE transmission is based at least in part on a received sidelink control information

Aspect 22: The method of any of Aspects 6-21, wherein the first UE is a COT responding UE.

Aspect 23: The method of any of Aspects 6-22, wherein the second UE is a COT initiating UE.

Aspect 24: A method of wireless communication performed at a first user equipment (UE), comprising: receiving, from a second UE, channel occupancy time (COT) sharing information (COT-SI) associated with a shared COT; selecting a channel access type and a cyclic prefix extension (CPE) in an autonomous manner based at least in part on the channel access type and the CPE being excluded from the COT-SI; and performing a sidelink transmission within the shared COT based at least in part on an outcome of a channel access procedure and the CPE.

Aspect 25: The method of Aspect 24, wherein the channel access type is a default channel access type, or the channel access type is an upgraded channel access type

Aspect 26: The method of Aspect 25, wherein the second channel access type is upgraded based at least in part on detecting another sidelink transmission from the second UE or a third UE in a slot prior to the sidelink transmission.

Aspect 27: The method of Aspect 26, wherein detecting another sidelink transmission is based at least in part on a received sidelink control information.

Aspect 28: The method of any of Aspects 24-27, wherein selecting the CPE is based at least in part on an autonomous selection and includes one of: a random selection, a sidelink transmission priority based selection, or a random selection based at least in part on a sidelink transmission priority.

Aspect 29: The method of any of Aspects 24-28, wherein the CPE is associated with a second set of CPEs based at least in part on the CPE being selected autonomously at the first UE

Aspect 30: The method of any of Aspects 24-29, wherein selecting the CPE comprises selecting a default CPE from a set of CPEs.

Aspect 31: The method of Aspect 30, wherein the default CPE is selected based at least in part on the sidelink transmission being associated with a partial resource block set allocation.

Aspect 32: The method of Aspect 30, wherein the default CPE is selected based at least in part on a receipt of a reservation message from a third UE for a resource starting at a same starting slot associated with the sidelink transmission.

Aspect 33: The method of Aspect 30, wherein the default CPE is selected based at least in part on the first UE transmitting a reservation message associated with the sidelink transmission.

Aspect 34: The method of Aspect 30, wherein the default CPE is predefined in a specification, configured for the first UE, or indicated to the first UE via sidelink control information.

Aspect 35: The method of Aspect 30, wherein the set of CPEs includes one or more prohibited CPEs.

Aspect 36: The method of Aspect 35, wherein the one or more prohibited CPEs are predefined in a specification or configured for the first UE.

Aspect 37: The method of Aspect 35, wherein the one or more prohibited CPEs are based at least in part on a detection of another UE transmission.

Aspect 38: The method of Aspect 37, wherein the detection of another UE transmission is based at least in part on a received sidelink control information

Aspect 39: The method of any of Aspects 24-38, wherein the first UE is a COT responding UE.

Aspect 40: The method of any of Aspects 24-39, wherein the second UE is a COT initiating UE.

Aspect 41: A method of wireless communication performed at a first user equipment (UE), comprising: receiving, from a second UE, channel occupancy time (COT) sharing information (COT-SI) associated with a shared COT; selecting a channel access type and a cyclic prefix extension (CPE) in an autonomous manner based at least in part on the COT-SI, wherein the channel access type is one or more of a default channel access type or an upgraded channel access type, and the upgraded channel access type is based at least in part on a detection of another sidelink transmission in a slot prior to a sidelink transmission; and performing a sidelink transmission within the shared COT based at least in part on an outcome of a channel access procedure and the CPE.

Aspect 42: The method of Aspect 41, wherein the other sidelink transmission is from the second UE or a third UE in the slot prior to the sidelink transmission.

Aspect 43: The method of any of Aspects 41-42, wherein the detection of the other sidelink transmission is based at least in part on a received sidelink control information.

Aspect 44: The method of any of Aspects 41-43, further comprising: selecting the CPE based at least in part on an autonomous selection that includes one of: a random selection, a sidelink transmission priority based selection, or a random selection based at least in part on a sidelink transmission priority.

Aspect 45: A method of wireless communication performed at a second user equipment (UE), comprising: splitting a channel occupancy time (COT) into a first sub-COT and a second sub-COT; transmitting, to a first set of user equipments (UEs), a first channel occupancy time (COT) sharing information (COT-SI) that indicates at least a first offset and a first duration associated with the first sub-COT; and transmitting, to a second set of UEs, a second COT-SI that indicates at least a second offset and a second duration associated with the second sub-COT.

Aspect 46: The method of Aspect 45, wherein the first COT-SI indicates one or more of a first channel access type or a first cyclic prefix extension (CPE).

Aspect 47: The method of any of Aspects 45-46, wherein the second COT-SI indicates one or more of a second channel access type or a second cyclic prefix extension (CPE).

Aspect 48: The method of any of Aspects 45-47, wherein the COT is formed based at least in part on a concatenation of different regions.

Aspect 49: The method of any of Aspects 45-48, wherein the first set of UEs includes one or more UEs.

Aspect 50: The method of any of Aspects 45-49, wherein the second set of UEs includes one or more UEs.

Aspect 21: The method of any of Aspects 45-50, wherein the first set of UEs and the second set of UEs include COT responding UEs.

Aspect 52: The method of any of Aspects 45-51, wherein the second UE is a COT initiating UE.

Aspect 53: An apparatus for wireless communication at a device, comprising a processor; memory coupled with the processor; and instructions stored in the memory and executable by the processor to cause the apparatus to perform the method of one or more of Aspects 1-44.

Aspect 54: A device for wireless communication, comprising a memory and one or more processors coupled to the memory, the one or more processors configured to perform the method of one or more of Aspects 1-44.

Aspect 55: An apparatus for wireless communication, comprising at least one means for performing the method of one or more of Aspects 1-44.

Aspect 56: A non-transitory computer-readable medium storing code for wireless communication, the code comprising instructions executable by a processor to perform the method of one or more of Aspects 1-44.

Aspect 57: A non-transitory computer-readable medium storing a set of instructions for wireless communication, the set of instructions comprising one or more instructions that, when executed by one or more processors of a device, cause the device to perform the method of one or more of Aspects 1-44.

Aspect 58: An apparatus for wireless communication at a device, comprising a processor; memory coupled with the processor; and instructions stored in the memory and executable by the processor to cause the apparatus to perform the method of one or more of Aspects 45-52.

Aspect 59: A device for wireless communication, comprising a memory and one or more processors coupled to the memory, the one or more processors configured to perform the method of one or more of Aspects 45-52.

Aspect 60: An apparatus for wireless communication, comprising at least one means for performing the method of one or more of Aspects 45-52.

Aspect 61: A non-transitory computer-readable medium storing code for wireless communication, the code comprising instructions executable by a processor to perform the method of one or more of Aspects 45-52.

Aspect 62: A non-transitory computer-readable medium storing a set of instructions for wireless communication, the set of instructions comprising one or more instructions that, when executed by one or more processors of a device, cause the device to perform the method of one or more of Aspects 45-52.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a first user equipment (UE), comprising:
one or more memories; and
one or more processors coupled with the one or more memories and configured to cause the first UE to:
receive, from a second UE, channel occupancy time (COT) sharing information (COT-SI) associated with a shared COT;
select a channel access type and a cyclic prefix extension (CPE) based at least in part on the COT-SI, wherein the channel access type is one or more of a default channel access type or an upgraded channel access type, and the upgraded channel access type is based at least in part on a detection of another sidelink transmission in a slot prior to a sidelink transmission; and
perform the sidelink transmission within the shared COT based at least in part on an outcome of a channel access procedure and the CPE.

2. The apparatus of claim 1, wherein the other sidelink transmission is from the second UE or a third UE in the slot prior to the sidelink transmission.

3. The apparatus of claim 1, wherein the detection of the other sidelink transmission is based at least in part on a received sidelink control information.

4. The apparatus of claim 1, wherein the one or more processors are configured to cause the first UE to:
select the CPE based at least in part on selection that includes one of: a random selection, a sidelink transmission priority based selection, or a random selection based at least in part on a sidelink transmission priority.

5. An apparatus for wireless communication at a first user equipment (UE), comprising:
one or more memories; and
one or more processors coupled with the one or more memories and configured to cause the first UE to:
receive, from a second UE, channel occupancy time (COT) sharing information (COT-SI) that indicates at least an offset, a channel access type, and a cyclic prefix extension (CPE) associated with a shared COT; and
select the channel access type and the CPE, as indicated by the COT-SI, based at least in part on a sidelink transmission to be transmitted at the offset; and
perform the sidelink transmission within the shared COT based at least in part on an outcome of a channel access procedure and the CPE.

6. The apparatus of claim 5, wherein the one or more processors are configured to cause the first UE to:
select the CPE based at least in part on the sidelink transmission that occurs at a start of a slot indicated by the offset in the COT-SI.

7. The apparatus of claim 5, wherein the CPE is associated with a first set of CPEs based at least in part on the CPE being indicated by the COT-SI.

8. An apparatus for wireless communication at a first user equipment (UE), comprising:
one or more memories; and
one or more processors coupled with the one or more memories and configured to cause the first UE to:
receive, from a second UE, channel occupancy time (COT) sharing information (COT-SI) that indicates at least an offset, a first channel access type, and a first cyclic prefix extension (CPE) associated with a shared COT; and
select, a second channel access type and a second CPE, different or same from the first channel access type and the second CPE indicated by the COT-SI, based at least in part on a sidelink transmission to be transmitted after the offset; and
perform the sidelink transmission within the shared COT based at least in part on an outcome of a channel access procedure and the second CPE.

9. The apparatus of claim 8, wherein the one or more processors are configured to cause the first UE to:
select the second CPE based at least in part on the sidelink transmission that occurs after a start of a slot indicated by the offset in the COT-SI.

10. The apparatus of claim 8, wherein the second channel access type is a default channel access type, or the second channel access type is an upgraded channel access type.

11. The apparatus of claim 10, wherein the second channel access type is upgraded based at least in part on a detection of another sidelink transmission from the second UE or a third UE in a slot prior to the sidelink transmission, and
the one or more processors are configured to cause the first UE to:
detect another sidelink transmission based at least in part on a received sidelink control information.

12. The apparatus of claim 8, wherein the one or more processors are configured to cause the first UE to:
select the second CPE based at least in part on a selection that includes one of: a random selection, a sidelink transmission priority based selection, or a random selection based at least in part on a sidelink transmission priority.

13. The apparatus of claim 8, wherein the CPE is associated with a second set of CPEs based at least in part on the CPE being selected at the first UE.

14. The apparatus of claim 8, wherein the one or more processors, to select the second CPE, are configured to cause the first UE to select a default CPE from a set of CPEs.

15. The apparatus of claim 14, wherein the one or more processors are configured to cause the first UE to:
select the default CPE based at least in part on the sidelink transmission being transmitted in accordance with a partial resource block set allocation.

16. The apparatus of claim 14, wherein the one or more processors are configured to cause the first UE to:
select the default CPE based at least in part on a receipt of a reservation message from a third UE for a resource that starts at a same starting slot associated with the sidelink transmission.

17. The apparatus of claim 14, wherein the one or more processors are configured to cause the first UE to:
select the default CPE based at least in part on the first UE that transmits a reservation message associated with the sidelink transmission.

18. (canceled)

19. (canceled)

20. (canceled)

21. (canceled)

22. An apparatus for wireless communication at a first user equipment (UE), comprising:
one or more memories; and
one or more processors coupled with the one or more memories and configured to cause the first UE to:
receive, from a second UE, channel occupancy time (COT) sharing information (COT-SI) associated with a shared COT;
select a channel access type and a cyclic prefix extension (CPE) manner based at least in part on the channel access type and the CPE being excluded from the COT-SI; and
perform a sidelink transmission within the shared COT based at least in part on an outcome of a channel access procedure and the CPE.

23. The apparatus of claim 22, wherein the channel access type is a default channel access type, or the channel access type is an upgraded channel access type.

24. The apparatus of claim 23, wherein the second channel access type is upgraded based at least in part on a detection of another sidelink transmission from the second UE or a third UE in a slot prior to the sidelink transmission, and the detection is based at least in part on a received sidelink control information.
